(19) United States
(12) Patent Application Publication
(10) Pub. No.: US 2016/0140668 A1
(43) Pub. Date: May 19, 2016

(54) SYSTEM TO ASSIST IN TAX COMPLIANCE

(71) Applicant: Bank of America Corporation, Charlotte, NC (US)

(72) Inventors: MATTHEW MAGUIRE, FORT MILL, SC (US); KUMARA SWARMY REDDY KARIYAPPA REDDY, CHARLOTTE, NC (US); MATTHEW ERIC NOREIKA, CONCORD, NC (US); ARUN KALLIKADAVIL, CHARLOTTE, NC (US); SUZANNE REDMAN, CHARLOTTE, NC (US)

(21) Appl. No.: 14/543,084

(22) Filed: Nov. 17, 2014

(51) Int. Cl. G06Q 40/00

(52) U.S. Cl. CPC G06Q 40/123

(57) ABSTRACT

The tax compliance tool includes a system, computer program product, and computer-implemented method for receiving at least one document comprising client tax data during an on-boarding process for a financial institution; validating the at least one document by: identifying a schema for the at least one document, and determining that the at least one document includes input in all fields based on the schema; extracting tax data from the at least one document; receiving at least one financial institution record associated with the client, wherein the at least one financial institution record is received from a database; comparing the tax data to the at least one financial institution record to identify inconsistencies; transforming client data based on the comparison of the tax data to the at least one financial institution record; and generating a report comprising the transformed client data.

### FIELD

The present invention relates to the field of systems that are used for verifying tax records and status associated with entities that are being on-boarded or that have had a status change.

### BACKGROUND

Financial institutions bring on new clients in a process called onboarding. During the onboarding process, multiple documents are provided by the customer or are publicly available regarding the customer. In some embodiments, laws, rules, and regulations require customers to perform certain actions, such as filing tax documents, if changes occur in customer information. Currently, however, it is difficult to maintain and/or view non-transformed information from different sources during the onboarding process.

The Foreign Account Tax Compliance Act (FATCA) is a U.S. law that requires U.S. entities to report their financial accounts held outside of the United States. If an entity has U.S. connections or indicia, the entity is required to report their accounts, but if the indicia can be cured or explained, then the entity may have different legal requirements. Thus, there is a need for a system to assist in tax compliance.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

Generally, systems, computer program products, and methods are described herein for an application and system integration framework that provides interoperability and scalability for user interfaces and workflow processes within and/or between institutions. One part of the system includes a tax compliance tool to assist users in complying with tax laws, rules, and regulations.

In various aspects, a system, computer program product, and computer-implemented method are configured to receive at least one document comprising client tax data during an on-boarding process for a financial institution; validate the at least one document by: identifying a schema for the at least one document, and determining that the at least one document comprises input in all fields based on the schema; extract tax data from the at least one document; receive at least one financial institution record associated with the client, wherein the at least one financial institution record is received from a database; compare the tax data to the at least one financial institution record to identify inconsistencies; transform client data based on the comparison of the tax data to the at least one financial institution record; and generate a report comprising the transformed client data.

In an embodiment, the system, computer program product, and computer-implemented method are further configured to identify U.S. indicia associated with the client in at least one of the tax data and the financial institution record; determine whether the U.S. indicia can be cured according to predetermined rules; cure the U.S. indicia by modifying at least one of the tax data and the financial institution records; and update the onboarding process after the U.S. indicia is cured.

In an embodiment, the system, computer program product, and computer-implemented method are further configured to: identify differences in anti-money laundering data in the tax data and the financial institution records; determine when the differences in anti-money laundering data between the tax data and the financial institution records require a change in circumstances review; and alert a user to the need for a change in circumstances review.

In an embodiment, the system, computer program product, and computer-implemented method are further configured to: monitor the financial institution data over time; determine a change in the anti-money laundering data; and determine whether a tax document should be revised based on the change in the anti-money laundering data.

In an embodiment, the system, computer program product, and computer-implemented method are further configured to generate a revised tax document based on the change in the anti-money laundering data; and provide the revised tax document to a user.

In some embodiments, the report including the transformed client data is customized for the client based on U.S. indicia associated with the client, wherein a client that has U.S. indicia is onboarded according to U.S. rules and wherein a client that does not have U.S. indicia is onboarded according to non-U.S. rules.

In an embodiment, the system, computer program product, and computer-implemented method are further configured to populate the transformed tax data to other departments of the financial institution.

To the accomplishment the foregoing and the related ends, the one or more embodiments comprise the features hereinafter described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates an integration framework system, in accordance with one embodiment of the invention;

FIG. 2 illustrates an integration framework setup process, in accordance with an embodiment of the invention;

FIG. 3 illustrates an integration framework implementation process, in accordance with one embodiment of the invention;

FIG. 4 illustrates a integration framework environment, in accordance with one embodiment of the invention;

FIG. 5 illustrates an on-boarding process using the integration framework, in accordance with an embodiment of the invention;

FIG. 6 illustrates an on-boarding entity profile user interface, in accordance with an embodiment of the invention;

FIG. 7 illustrates an on-boarding entity data user interface, in accordance with an embodiment of the invention;

FIG. 8 illustrates an on-boarding owners user interface, in accordance with an embodiment of the invention;

FIG. 9 illustrates an on-boarding regional user interface, in accordance with an embodiment of the invention;

FIG. 10 illustrates an on-boarding documents user interface, in accordance with an embodiment of the invention;

FIG. 11 illustrates an on-boarding history user interface, in accordance with an embodiment of the invention;

FIG. 12 illustrates a high level process for evaluating tax compliance, in accordance with an embodiment of the invention;

FIG. 13 illustrates a schematic diagram of elements of the integration framework and tax compliance tool, in accordance with an embodiment of the invention;

FIG. 14 illustrates a tax compliance process using the tax compliance tool, in accordance with an embodiment of the invention;

FIG. 15 illustrates an exemplary graphical user interface for reviewing and displaying a work queue for the tax compliance tool, in accordance with an embodiment of the invention;

FIG. 16 illustrates an exemplary graphical user interface for reviewing and displaying client tax data, in accordance with an embodiment of the invention; and

FIG. 17 illustrates an exemplary graphical user interface for reviewing and displaying the results of due diligence, in accordance with an embodiment of the invention.

### DETAILED DESCRIPTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Generally, systems, computer program products, and methods are described herein for an application and system integration framework that provides interoperability and scalability for user interfaces and workflow processes within and/or between institutions. The integration framework system 100 may be used to create one or more applications to display data to users on user interfaces and allow the users to take actions on the data. The integration framework system 100 may be used to create any application for any type of data and display the data as desired by one or more users. The applications created by integration framework system 100 are interoperable, scalable, and updateable without having to recode the applications.

The integration framework system 100 includes the storage of data in one or more data files within a data storage database 110. The data files store the data that is eventually displayed to a user in a user interface 150. The data may be stored in a table, or other like spreadsheet, for example, an “.xls” file. In some embodiments the data may be stored in one or more data files depending on the ultimate output desired in the user interface 150. As an example, the data may include a lookup data file 112, a component data file 114, and an entitlement data file 116. The lookup data file 112 may include any type of element data for display in a user interface 150. For example, in one embodiment of the invention the lookup data file 112 may comprise a list of questions and the one or more answer (e.g., pre-defined answers) associated with the list of questions. The component data file 114 may comprise component data types indicating the types of element data that is stored in the lookup data file 112. For example, with respect to the example of the questions and answers, the component data types may include an indication that the answers to the questions are in a dropdown list form, a check box form, a text answer form, or the like. The entitlement data file 116 may comprise a user type (e.g., entitlement type) indicating the one or more users that are allowed to access and/or take actions on the element data in the lookup data file 112. Returning to the example of the element data being questions and answers, the user type may include all users, manager users, analysis users, a combination of types of users, a list of users, individual users, or other like user types that limit the one or more users that may view and/or take actions on the one or more questions in the lookup data file 112.

In some embodiments the integration framework system 100 may also store the data from the data files as searchable linked data 132 in a linked data storage database 130. In some embodiments the linked data 132 may be name/value pairs, or other types of linked data. The linked data 132 stored in the linked data storage database 130 allows searching, reading, and use of the linked data 132 by any type of application regardless of the type of application or code in which the application is created. In one embodiment, the data from the data files may be stored as an “xml” file. With respect to the example of the element data being questions and answers, the linked data may include a question identifier in the data files that links the questions and answers in the lookup data file 112, to the component data for the questions and answers in the component data file 114, and the user type for the questions and answers in the entitlement data file 116.

In addition to data files and linked data file, the integration framework system 100 may include one or more templates (e.g., first template 122, second template 124, Nth template 126) in a template database 120, which provide the structure for display of the element data in the user interfaces 150 within the integration framework application. The templates may include the tabs, sub-tabs, sections, sub-sections, entries within each, or the like, which provide an outline of how the data from the data files is presented in the user interfaces 150. In other embodiments of the invention the templates may include types of structure for the user interfaces 150 other than tabs, sections, and the like. In the example discussed herein with respect to the element data being questions and answers, the templates are used to provide the framework for the user interfaces 150 in which the questions and pre-defined answers are displayed to the user in the various tabs, sub-tabs, sections, sub-sections, or the like.

The integration framework system 100 may further include transformation style-sheets, which may be pre-determined or customizable for various users. The style-sheets may be applied to the data in the templates in order to indicate how to illustrate the element data from the data files in the user interfaces 150 as the user desires the element data to be illustrated. In further accord with the example of questions and answers discussed herein, a first style-sheet may indicate that the questions are to be illustrated one after another in a vertical orientation from top to bottom, and a second style-sheet may indicate that the questions are to be illustrated first in a left to right orientation before proceeding to the next vertical line.

The integration framework system 100 also includes a rules engine 140 that defines what element data are shown, how the element data are shown, when the element data are shown, and to whom the element data are shown in the user interfaces 150. With respect to the example of the data files comprising questions and answers, types of answers, and entitlements of users, the rules engine 140 may identify what questions to display to the user in the user interface 150 based on the user's profile, the user type from the entitlement data file, and how the user answers one or more of the questions in the user interface 150. For example, based on the type of user logged into the application, and the user type data from the data files, the rules engine 140 only displays the questions to the user that the user is approved to view or take actions on. Moreover, if a user takes an action by selecting “yes” as an answer to a question, the rules engine 140 provides a first set of questions to the user in the user interface 150, and if the user answers the same question with “no,” the rules engine 140 provides a second set of questions to the user in the user interface 150. The rules engine 140 may be developed to provide the business logic, rules, and behavior for all the element data stored in the data files and eventually displayed in the user interfaces 150.

The integration framework system 100 in some embodiments may also include a workflow engine 160, which sends notifications to other users based on the actions a user takes on the user interface 150. The workflow engine 160 gathers information from the user interfaces 150 and dynamically identifies the workflow path of the element data and associated user actions. For example, if the user takes an action on the element data provided in the user interface 150, the workflow engine 160 determines if the user's action should be sent to another user (e.g., a manager user) to approve the action taken by the user or to take other actions. In some embodiments, the workflow engine 160 sends the notification of actions to the correct user. In the example discussed herein, after the first user answers one or more of the questions, a notification may be sent to a second user to approve or validate the answers to the questions provided by the first user. As explained in further detail later workflow engine 160 includes a provision to deal with multiple parallel requests and identifies any conflicting actions taken by users.

The integration framework system 100 may further include a workflow storage database 170 that stores the actions taken by the one or more users on the element data displayed to the users through the user interfaces 150. The workflow storage database 170 may include a record storage mechanism for object recovery with user draft provisions that allows for storage and retrieval of all the recorded actions and element data and the associated user that provided the actions. In the example discussed herein with respect to the questions and answers, the workflow storage database 170 may store the first user's answers to one or more of the questions and/or the second user's approval of the one or more questions answered by the first user, or the second user's answers to one or more other questions. As was the case with the linked data, the user actions may be stored as searchable data that may be read by any type of application regardless of the type of application or code of the application. For example, in one embodiment the workflow storage database 170 stores the user actions in key value pairs in an “xml” file to provide interoperability with the user interfaces 150.

In addition, a reporting engine 180 may also be included in the integration framework system 100. The reporting engine 180 is capable of generating various periodic reports. The reporting engine 180 may also be capable of allowing users to create customizable reports for the current data or historical data reflecting the data as of a specific date provided by the users.

The integration framework system 100 may also include a data distribution engine 190 that provides on demand information (e.g., status information related to the element data and user actions) in real-time or near real-time. The data distribution engine 190 may include entitlement restrictions for the users that limits the use and access of the on-demand information.

The integration framework system 100 may also include other databases, applications, and systems that may interface with the data stored in the integration framework system 100. For example, in one embodiment the applications may include, but is not limited to, a translation application that may translate stored text, such as when answers to the questions are not provided as pre-defined answers.

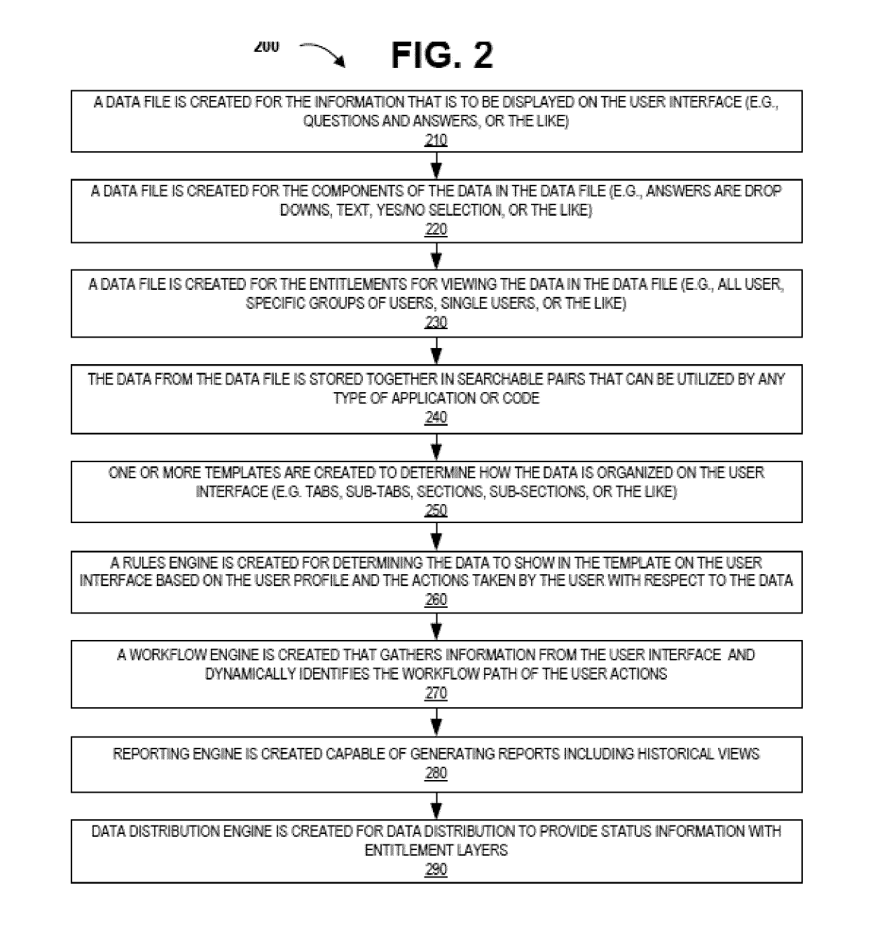

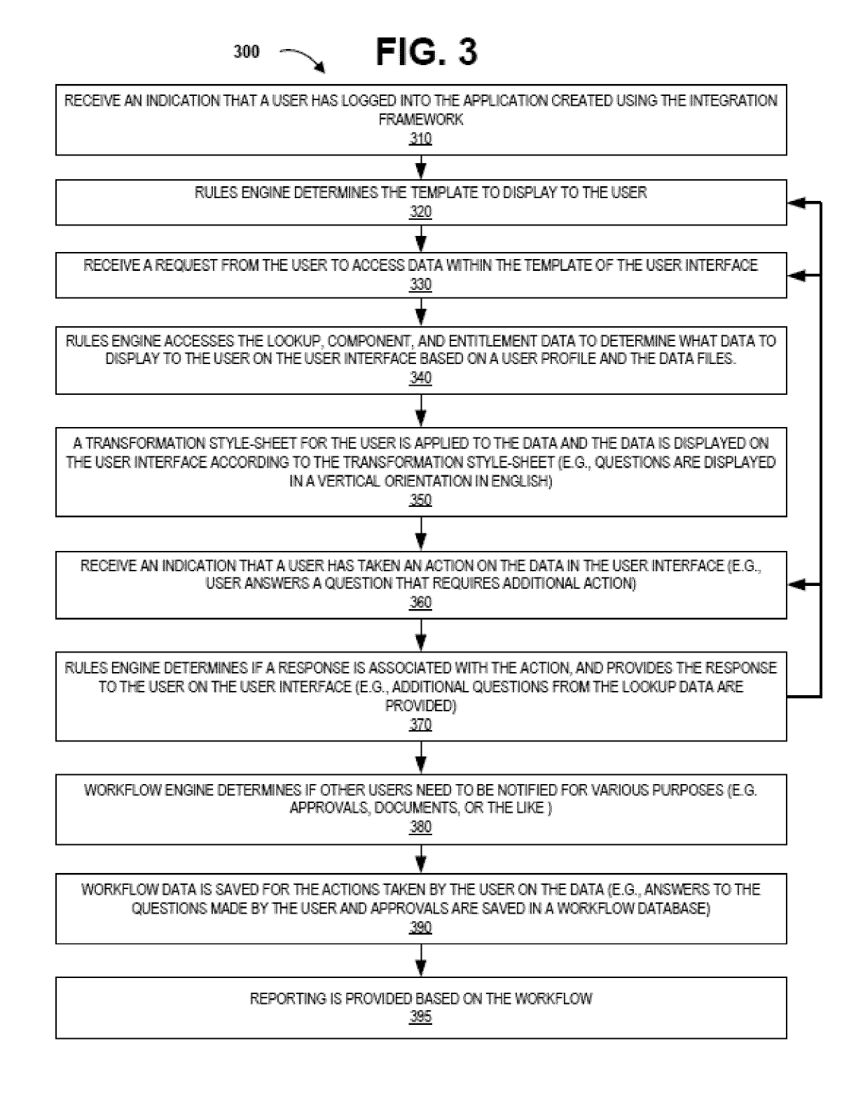

The example discussed above with respect to the data comprising questions and answers is discussed in further detail with respect to FIGS. 2 and 3. FIG. 2 provides an application creation process 200 related to creating an application using the integration framework system 100, and FIG. 3 provides an application operation process 300 related to how the integration framework system 100 operates as a user is using the application created by the integration framework system 100.

As illustrated in FIG. 2, in one example a customer application for storing customer data may be created using the integration framework system 100. The customer application created may have a number of questions regarding customers, and associated potential answers for the questions.

As illustrated by block 210 in FIG. 2, a data file is created for the element data that is to be displayed on the user interface 150. As such, with respect to the example customer application, the questions and answers are first populated into a lookup data file 112. The lookup data may include a question identifier (e.g., Q1, Q2, Q3 . . . QN) or other like identifier, the associated question, and the associated one or more answers (e.g., pre-defined answers) for the question. The questions for the customer application may include for example; Q1: What is your geographic region; Q2: Are you a business or an individual; Q3: What is your business identification number; Q4: What is your individual identification number; QN: Other like questions. The lookup data file may also store answers for the questions, such as Q1: North, East, South, West; Q2 Business/Individual, or the like.

As illustrated in block 220 in FIG. 2, a data file is created indicating the component data type of the element data located in the data file created in block 210. Therefore, in addition to populating a lookup data file 112, a component data file 114 may also be populated with a reference to the questions in the lookup data file 114, through the question identifier (e.g., Q1, Q2, Q3 . . . QN), or another identifier (e.g., 1-2-3, or the like). The component data file 114 includes an associated answer type for each of the question identifiers, which identifies types of answers for each of the questions in the lookup data file 112. For example, the component data file 114 may include the question identifier for Q1, Q2, Q3, Q4, . . . QN, and an associated answer type identifier, such as for example a dropdown identifier (e.g., DROPDOWN) for Q1 answers, a selection box identifier (e.g., SELECTION) of business/individual for Q2 answers, a five digit text box (e.g., TEXT5) for Q3 answers, and a seven digit text box (e.g., TEXT7) for Q4 answers, and other like answer types for the questions up to QN.

Block 230 of FIG. 2 illustrates that a data file is created for the entitlement data for viewing or taking actions on the element data in the data file created in block 210. Therefore, in addition to populating the lookup file 112 and the component file 114, an entitlement data file 116 is populated with a reference to the questions in the lookup data file 112, again through the question identifier (e.g., Q1, Q2, Q3 . . . QN) or other like identifier. User types are then associated with the question identifier in the entitlement data file 116, indicating the users that have access to view or answer the questions through the use of a user type reference. For example, the entitlement data file may include an all user type identifier (e.g., ALL USERS) for answering Q1 and Q2, but a specific user type identifier (e.g., USER 1) or group of users identifier (e.g., USER GROUP 1) to answer Q3 and Q4.

The types of data entered into the data files described herein are only an example of the types of data that could be utilized by the integration framework system 100. It should be understood that any type of data may be included in the data files and work within the integration framework system 100 as is discussed and illustrated for the specific examples herein.

As illustrated in block 240 of FIG. 2, the data from the data files may be stored together as linked data in a linked data storage database 130. For example, the question identifiers (e.g., Q1, Q2, Q3 . . . QN) in the lookup data file 112, the component data file 114, and the entitlement data file 116 links the data in each data file, within the linked data storage 130. As previously discussed the linked data 132 stored in the linked data storage database 130 allows searching and reading of the linked data 132 by any type of application regardless of the type of application or code in which the application is created. As previously discussed the data from the data files may be stored in an “xml” database.

Block 250 illustrates that one or more templates are created to determine how the data are organized on the user interface. The templates provide the underlining structure in which the questions and answers are eventually populated and displayed on the user interfaces 150. As previously discussed the templates may include the tabs, sub-tabs, sections, sub-sections, entries within each, or the like, that indicate how the element data from the data files is presented in the user interfaces 150. In one embodiment, the names for the tabs, sub-tabs, sections, or the like are stored in the data files, such that only the data files need to be updated when a name of a tab, sub-tab, section, or the like changes. In other embodiments the names of the tabs, sub-tabs, sections, or the like are created in the template itself.

As illustrated by block 260 in FIG. 2, once the one or more templates are formed the rules engine 140 is generated for decisioning how the templates are populated with the element data from the data files. The rules engine 140 provides what data are shown, how the data are shown, when the data are shown, and to whom the data are shown. In the example discussed herein the rules engine may recite that Q1 should be located in TAB 1, SECTION 1, while Q2, Q3, and Q4 should be located in TAB 2, SECTION 1, SUBSECTION 3. Moreover, the rules engine may recite that Q3 is only displayed in the user interface when the answer to Q2 is “Business” and Q4 is only displayed in the user interface when the answer to Q2 is “Individual.”

The rules engine 140 is set up with general references back to the data files (or the linked data 132), such that the rules engine 140 need only be programmed once. If any changes are required for what the data are, the type of data, who can access the data, or the like, only the data files need to be updated and the rules engine 140 will still function to display the data in the data files on the user interfaces 150 as originally defined in the rules engine 140. For example if access to Q3 and Q4 needs to be changed from “USER GROUP1” to “USER1” all that is required is to change the user type in the entitlement data file 116. In a second example, if a Q5 needs to be added based on the answer to Q2, the data files are simply updated with the new Q5 and the rules engine populates Q5 in the template in the user interface based on the answer to Q2.

As illustrated by block 270 in FIG. 2, a workflow engine 160 is created that gathers information from the user interfaces 150 and dynamically identifies the workflow path for the element data based on user actions with respect to the element data. For example, with respect to the questions and answers in a customer application, the workflow engine 140 may identify that a first user 4 is logged into the customer application and is entering information for a first customer. The first user 4 may have entered the answers for Q1 and Q2, but based on the rules engine 140 the workflow engine 150 identifies that other users (e.g., a second user 6) are needed to answer either Q3 or Q4 (depending on the answer to Q2). The workflow engine 160 may send a notification to the other users (e.g., a second user 6) to answer Q3 or Q4 after identifying that the first user 4 has answered Q2. In some embodiments the workflow engine 160 may be programmed to interact with the rules engine 140 in order to determine the workflow path of the data; however, in other embodiments of the invention the workflow data are programmed into the rules engine 140 itself.

As illustrated by block 280 in FIG. 2, a reporting engine 180 is created that is capable of generating reports including historical views of the element data and user actions. For example, the data in the customer application may be provided to various users throughout the institution, as needed. In some embodiments the reporting engine 180 may be a plug-in application that interacts with the customer application created using the integration framework system 100.

Block 290 of FIG. 2 also illustrates that a data distribution engine 190 is created for data distribution of the element data and user actions in the application and to provide status information of the element data and user action. The data distribution engine 190 includes entitlements layers for users of applications within the integrated framework systems 100. In some embodiments the data distribution engine 190 may be a plug-in application that interacts with the customer application created using the integration framework system 100. In some embodiments of the invention the reporting engine 180 and the data distribution engine 190 may be included in a single engine.

FIG. 3 provides an application operation process 300 related to how the integration framework system 100 operates as a user is using an application created within the integration framework system 100.

In operation, as illustrated in block 310 of FIG. 3, the integration framework system 100 receives an indication that a user is logging into the customer application created within the integration framework system 100. The integrated framework system 100 determines the user, for example based on user profile data that may either be stored inside the application using the integrated framework system 100 or accessed as a plug-in to the integrated framework system 100 (e.g., user directory within the institution).

As illustrated by block 320, in response to the user logging into the application, the rules engine 140 determines the template to provide to the user based, in part, on the user profile and how the user logged into the application, for example a user may log into the full application and the full application template is provided (e.g., TEMPLATE 1), or the user may log into a light version of the application and a light template is provided (e.g., TEMPLATE 2). Thereafter, the application then displays the template to the user in the user interface 150 accordingly.

Block 330 illustrates that the application receives an indication that a user would like to take an action within the application. For example, the user may take an action by indicating the user would like to answer questions for a particular customer.

As illustrated by block 340, at this point the rules engine 140 accesses the lookup data file 112, the answer type for the associated question answers from the component data file 114, and the user type from the entitlement data file 116 (or alternatively accesses this information collectively in the linked data file 132) in order to determine what questions should be displayed to the user in response to the user action.

As illustrated in block 350 the rules engine 140 within the integration framework system 100 applies a general style-sheet or a customized style-sheet (e.g., style-sheet that displays the questions from top to bottom) to the questions and answers, based on the user preferences, and displays the questions and answers in the associated answer type (e.g., a dropdown) to the user in the user interface 150 using the template according to the style-sheet.

As illustrated by block 360 the application in the integration framework system 100 receives an indication that the user would like to take an action with respect to the data in the user interface 150, such as answering a question about the customer in the user interface 150.

Block 370 illustrates that once the user takes an action on a question (e.g., selecting a Business or Individual for Q2), the rules engine 140 determines any additional questions or other responses that should be provided to the user in the user interface 150 based on the lookup data, the entitlement user type for additional questions, and the user profile of the user taking actions on the questions. If the rules engine 140 determines that additional questions should be provided in the user interface 150, the style-sheet is applied to the additional questions, if any, and the additional questions are displayed to the user in the user interface 150 based on the template and the style-sheet.

The user may repeat blocks 320 through 370 until the user has taken all of the actions that the user would like to take within the application. For example, until the user has answered all of the questions within a section of the template or within the various section of the template for one or more customers.

As illustrated by block 380, the workflow engine 160 determines if other users (e.g., second users 6) should be notified of any actions taken by the user (e.g., first user 4) or notified of actions that that the other users need to take. For example, the questions answered by a first user 4 may need to be confirmed, or otherwise approved, by a second user 6 before the questions are finalized for a particular customer within the customer application. The workflow engine 160 sends notifications or links to the second user 4 whenever the additional actions are required within the user interface 150 for the element data related to one or more the customers. The workflow engine 160 facilitates completing the tasks for the processes that are incorporated into an application created using the integration framework system 10.

As illustrated by block 390 of FIG. 3, the application may save any actions the various users take with respect to element data for the one or more of the customers in a workflow storage database 170. For example, if the user answers all of the questions for a particular customer, the changes for that customer are stored in the workflow storage databases 170. Also, if approval has been made with respect to user actions, approval data may also be stored within the workflow storage database 170. As previously discussed the workflow storage database 170 may store data in a format that is readable by any application with any type of code to facilitate interoperability between applications and institutions.

Block 395 of FIG. 3 illustrates that reporting of the element data and user actions are provided based on the workflow data stored in the workflow data storage database 170.

The integration framework system 100 described herein allows any user to see the same information in customized interfaces based on the entitlement of the user, how the user wants to the see the information, and the rules related to what is shown based on the selections made by the user. For example, a user taking an action on a question located in a specific region may be required to take additional actions to answer a number of additional questions; however, the same user (or a different user) located in another region may not be required to take any additional actions. Moreover, in the example application, since the questions and associated answers are known, the questions and answers may be translated within the data files, such that the questions and answers may be provided to the users in any language. Therefore, the integration framework system 100 creates customizable views for individual users all over the world that may have different personal requirements for viewing data, as well as different regulatory requirements based on the location of the user.

The present invention allows for interoperability and scalability for workflow processes within and/or between institutions because if any of the data needs to be changed, only the original data files are updated and the rest of the integration framework system 100 continues to operate without needed additional changes to the code of the applications within the integration framework system 100. For example, if questions change, the answers in the element data file are updated, or if user access to individual questions changes, the entitlement type is updated, and the application will continue to operate without having to reprogram the template or rules engine 140.

These embodiments only discuss some of the features of the integrated framework, and as such, these and other embodiments of the invention are discussed in further detail throughout this specification below.

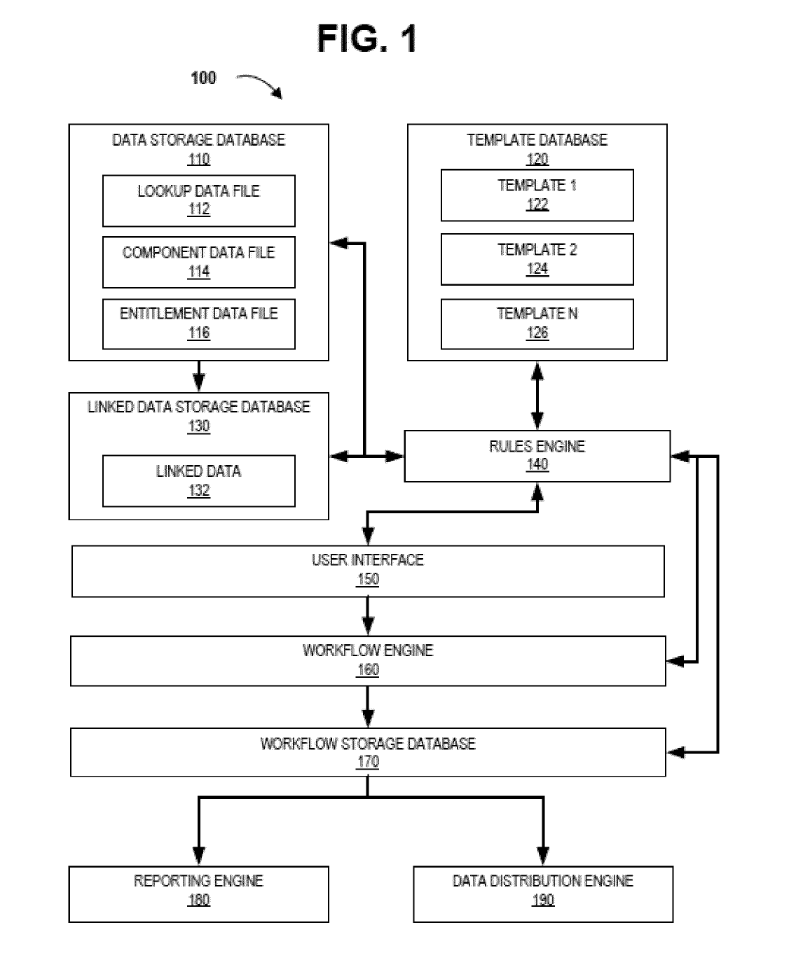

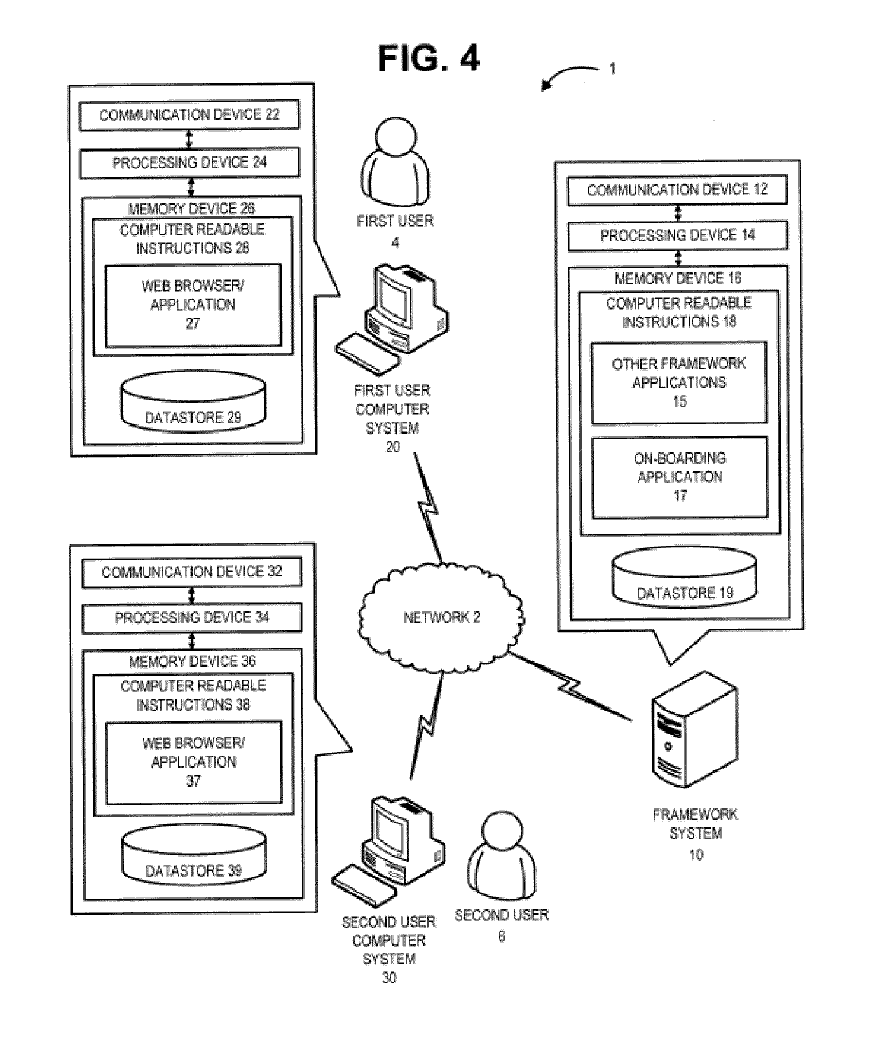

FIG. 4 illustrates an integration framework system environment 1, in accordance with one embodiment of the invention. As illustrated in FIG. 4, one or more integration framework systems 10 are operatively coupled, via a network 2, to first user computer systems 20, and second user computer systems 30. In this way one or more first users 4 and second users 6 may utilize the first user computer systems 20 and second user computer systems 30 to access the framework systems 10 to utilize the framework applications 15 (e.g., applications created using the integration framework systems 100), such as the on-boarding framework application 17 described in further detail below. The integration framework system 10 is illustrated in FIG. 4 as a single system; however, the integration framework system 10, may be made up of one or more systems, databases, engines, applications, or the like, as described for example with respect to the integration framework system 100 illustrated in FIG. 1.

The network 2 may be a global area network (GAN), such as the Internet, a wide area network (WAN), a local area network (LAN), or any other type of network or combination of networks. The network 2 may provide for wireline, wireless, or a combination of wireline and wireless communication between devices on the network 2.

In some embodiments of the invention the first user 4 and the second user 6 (e.g., employees, agents, contractors, legal representatives, or the like) affiliated with an institution have access to the framework system 10 for either creating the framework applications 15 or utilizing the framework application 15 after the applications are developed. In the embodiment of the invention described below the first user 4 has first access rights to the data within the on-boarding application 17 and the second user 6 has second access rights to the data within the on-boarding application 17. For example, the first user 4 may be tasked with on-boarding an entity in order to allow the first user's institution to comply with internal and external regulation before doing business (e.g., entering onto financial transactions) with the entity. The second user 6, may be tasked with additional on-boarding of the entity, or otherwise, with approving the on-boarding performed by the first user 4. One or more additional users may also on-board or complete other tasks before the entity is approved for entering transactions with the institution performing the on-boarding the entity.

As illustrated in FIG. 4, the framework system 10 generally comprise a communication device 12, a processing device 14, and a memory device 16. The processing device 14 is operatively coupled to the communication device 12 and the memory device 16. As used herein, the term “processing device” generally includes circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 14 uses the communication device 12 to communicate with the network 2 and other devices on the network 2, such as, but not limited to, the first user computer systems 20 and the second user computer systems 30. As such, the communication device 12 generally comprises a modem, server, or other device for communicating with other devices on the network 2.

As further illustrated in FIG. 4, the financial institution systems 10 comprise computer-readable instructions 18 stored in the memory device 16, which in one embodiment includes the computer-readable instructions 18 of framework applications 15 (e.g., mobile applications, cloud applications, system applications, database applications, or other like applications), such as an on-boarding framework application 17. The computer-readable instructions 18 may further comprise the rules engine 140, workflow engine 160, reporting engine 180, and data distribution engine 190. In some embodiments, the memory device 16 includes a datastore 19 for storing data related to the financial institution systems 10, including, but not limited to, data created and/or used by the framework applications 15. The data store 19 may further include the data storage database 110 with the data files, the template database 120, the linked data storage database 130, and/or the workflow storage databases. In other embodiments of the invention the applications, engines, and databases may be completely or partially located on other computer systems, such as first user computer systems 20 or second user computer system 30, or other systems.

The on-boarding application 17 is a tool that consolidates and ensures consistent implementation of business compliance with regulatory policy (e.g., anti-money laundering (“AML”) policy) across a global business that is required to comply with regulations of international, regional, country specific, local jurisdictions, or the like. The on-boarding application 17 facilitates the work flow, approvals, documents, reporting, and other information using dynamic rules that dictate the on-boarding elements based on customer type, booking entity, location of the authorized approval, special products, data collected, and the like, which are used to dynamically evaluate the client's on-boarding potential regulatory issues, and the actions used to mitigate potential regulatory issues with the entity being on-boarded.

As illustrated in FIG. 4, the first user 4 may access the on-boarding application 17 through a first user computer system 20. The first user computer system 20 may be a desktop, laptop, tablet, mobile device (e.g., smartphone device, PDA, phone, or other like mobile device), or any other type of computer that generally comprises a communication device 22, a processing device 24, and a memory device 26. The processing device 24 is operatively coupled to the communication device 22, and the memory device 26. The processing device 24 uses the communication device 22 to communicate with the network 2 and other devices on the network 2, such as, but not limited to, the framework systems 10, the second computer systems 30, and/or other systems. As such, the communication device 22 generally comprises a modem, server, or other device for communicating with other devices on the network 2 and/or a keypad, keyboard, touch-screen, touchpad, microphone, mouse, joystick, other pointer device, button, soft key, and/or other input device(s) for communicating with the first user 4.

As illustrated in FIG. 4, the first user computer system 20 may have computer-readable instructions 28 stored in the memory device 26, which in one embodiment includes the computer-readable instructions 28 of a web browser or application 27 that allows the first user 4 to access the on-boarding application 17, or the other framework applications 15. In some embodiments, the memory device 26 includes a datastore 29 for storing data related to the first user computer system 20, including but not limited to data created and/or used by the web browser or application 27.

As illustrated in FIG. 4, the second user computer system 30 generally comprises a communication device 32, a processing device 34, and a memory device 36. The processing device 34 is operatively coupled to the communication device 32 and the memory device 36. The processing device 34 uses the communication device 32 to communicate with the network 2 and other devices on the network 2, such as, but not limited to, the first user computer system 20, the framework systems 10, and/or other systems. As such, the communication device 32 generally comprises a modem, server, or other device for communicating with other devices on the network 2 and/or a keypad, keyboard, touch-screen, touchpad, microphone, mouse, joystick, other pointer device, button, soft key, and/or other input device(s) for communicating with the second user 6.

As further illustrated in FIG. 4, the second user computer system 30 comprise computer-readable instructions 38 stored in the memory device 36, which in one embodiment includes the computer-readable instructions 38 of a web browser or application 37 that allows a second user 6 to access the on-boarding application 17, or other framework application 15. In some embodiments, the memory device 36 includes a datastore 39 for storing data related to the employee computer systems 30, including but not limited to data created and/or used by the web browser or application 37.

As previously indicated, in some embodiments of the invention the on-boarding application 17, or the other framework applications 15, may be located completely or partially on the framework systems 10, first user computer system 20, second user computer system 30, or other systems not specifically illustrated or described with respect to FIG. 4.

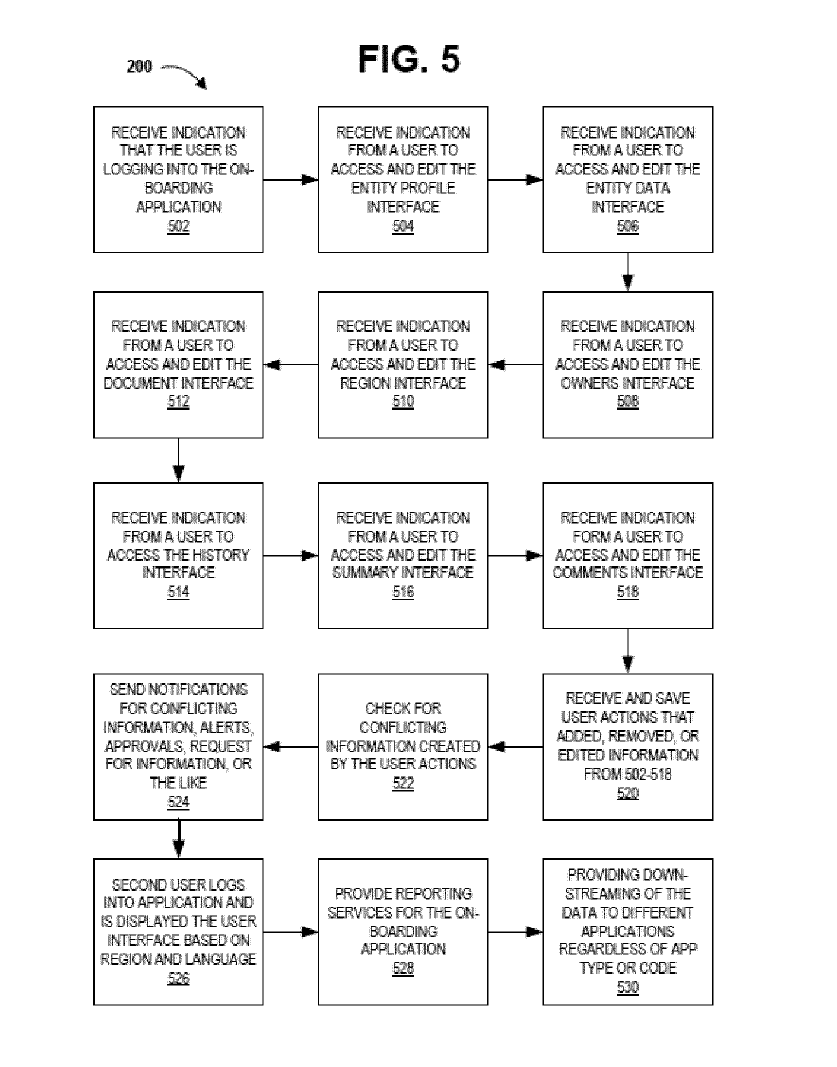

FIG. 5 illustrates an on-boarding application process 500 using the integration framework system 100, in accordance with an embodiment of the invention. As previously discussed the on-boarding application 17 is a tool that consolidates and ensures consistent implementation of business compliance with regulations (e.g., anti-money laundering (“AML”) policy) across a global business that is required to comply with regulations of international, regional, country specific, or local jurisdictions, or the like. The on-boarding application 17 facilitates the work flow, approvals, documents, reporting, and other information using dynamic rules that dictate the on-boarding elements based on customer type, booking entity, location of the authorized approval, special products, data collected, and the like, which are used to dynamically evaluate the client's on-boarding potential regulatory issues, and the actions used to mitigate the potential regulatory issues with the entity being on-boarded, as is explained in further detail below.

An institution may utilize the on-boarding application 17 to consolidate all of the institution's regulatory requirements in a single data and document repository that allows global leveraging of on-boarding entities and reduction of redundant on-boarding systems. The on-boarding application provides the ability to manage the approval process for confirming that client entities and prospective client entities comply with all of the regulatory requirements on an international, regional, and local level. The on-boarding application 17 further allows for the set-up and maintenance of the products involved in the transactions between the institution and the entities being on-boarded, as well as the reporting and monitoring of the products and transactions made with entities around the world as the product, transactions, and the business of the entities change.

As illustrated by block 502 the first user 4 logs into the on-boarding application 17. As previous described when a user logs into an application created using the integration framework system 100, the rules engine 140 determines the template, and displays the template in the user interface 150.

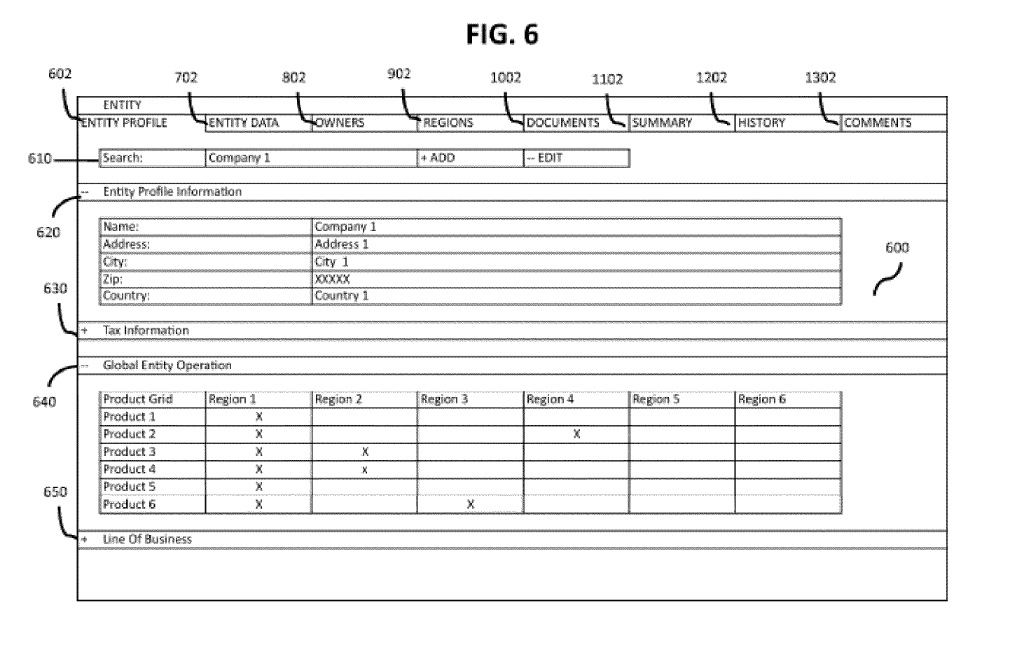

As illustrated in block 504 of FIG. 5, the first user 4 may select the entity profile tab 602 in order to access an entity profile interface 600 to create an entity profile for a new entity, or otherwise edit an entity profile that has already been at least partially on-boarded for one or more products, as illustrated in FIG. 6. By selecting the entity profile tab 602 the entity profile interface 600 is displayed to the first user 4. The first user 4 may search for a specific entity that already exists to view the on-boarded entity information, search for a specific entity to edit the profile, or add a new entity to the on-boarding application 17. For example, the first user 4 may take these actions by utilizing the company search section in the user interface 610. The entity profile interface 600 illustrates a number of sections within the entity profile tab 602 that may be expanded or hidden to allow the first user 4 to view, add, update, or remove (e.g., edit) information about an entity. As an example, the first user 4 may update general information for the entity in an entity information section 620, such as the entity name and address. The first user 4 may also provide tax information for the entity to help provide information for regulatory compliance. The entity profile interface 600 may also include a global entity product grid section 640 that indicates the products and regions for which and in which the first user 4 wants to on-board the entity. For example, the first user 4 may want to on-board the entity for entering into product 3 transactions with the entity in region 2 and product 6 transactions with the entity in region 3. The product grid may illustrate that the entity is accepted for transactions, is in process for acceptance, is rejected, or other like indicator that identifies the status of the on-boarding for products and regions for which the entity is being on-boarded. In some embodiments the on-boarding indicators in the product grid may have links that allow the first user 4 to view, add, update, or remove (e.g., edit) information related to the on-boarding process for the specific products and regions. In other embodiments of the invention, the entity profile interface 600 may also have a line of business section 650 that allows the first user 4 to view, add, update, or remove (e.g., edit) information related to one or more lines of businesses and contact information for the lines of business that are involved in on-boarding the entity for one or more products in one or more regions.

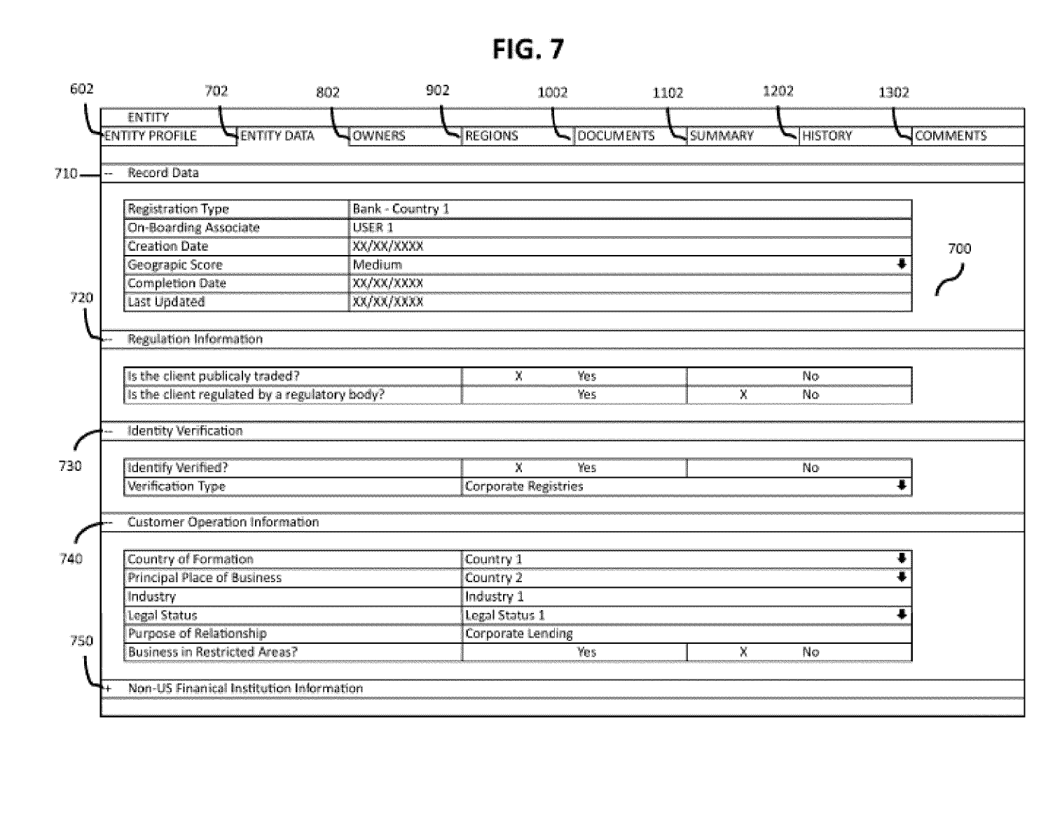

As illustrated in block 506 of FIG. 5, the first user 4 may select the entity data tab 702 in order to access an entity data interface 700 allowing the first user 4 to view, add, update, or remove (e.g., edit) entity data related to the entity on-boarded or being on-boarded, as illustrated in FIG. 7. As illustrated in the entity data interface 700 in FIG. 7, the first user 4, for example, may enter or update the record data section 710 for information related to the entity and the user that is on-boarding the entity. For example the record data section, includes information related to the registration type, the associate on-boarding the entity, the creation date of the on-boarding record, a geographic score indicating potential issues with the entity based on the geography in which the entity operates (e.g., operates in North America and South America), the completion data of the on-boarding, and/or the date the entity was last updated. The entity data interface 700 also includes a regulation information section 720, including information regarding if the company is public or private, is the entity regulated by a governing body, or other like regulation information. The entity data interface 700 may also comprise an identity verification section 730 that indicates if the identity of the entity has been verified and how the entity has been verified. A customer operation information section 740 may also be included in the entity data interface 700. The customer operation information section 740 may include the country of formation, the principle place of business, industry, legal status, purpose of the relationship with the entity, business practices in restriction areas, or other like operation information. Furthermore, in one embodiment the customer operation information section 740 may also include a foreign operation information section 750 related to the operations of the entity in foreign countries.

The regulation information section 720, and other sections within the user interfaces 150 provide examples of questions that are provided by the rules engine 150 based on the first user's 4 answers to other questions. For example, as illustrated, if the first user 4 answers “yes” to the question “Is the client publically traded?” the follow-up question provided by the rules engine 150 is “Is the client regulated by a regulatory body?” Alternatively, if the first user 4 answers “no” to the question “Is the client publically traded?” then alternative questions may be provided related any public information that may available for the private company.

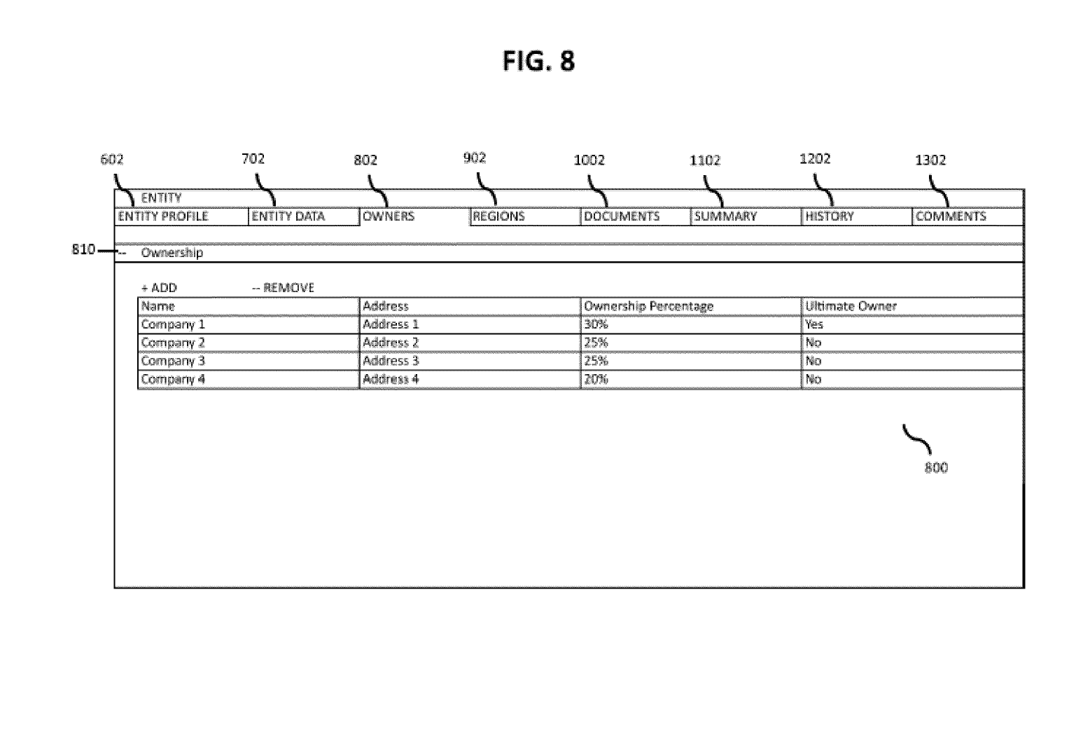

As illustrated in block 508 of FIG. 5, the first user 4 may select the owner's tab 802 in order to access the owner's interface 800 allowing the first user 4 to view, add, update, or remove (e.g., edit) owner's data related to the entity on-boarded or being on-boarded, as illustrated in FIG. 8. As illustrated in the owner's interface 800 the first user 4 may add or remove information related to the one or more companies or individuals that have ownership stakes in the entity on-boarded or being on-boarded, such as name, address, ownership percentage, ultimate owner (e.g., indicating if the company listed is the true owner), or other like ownership information.

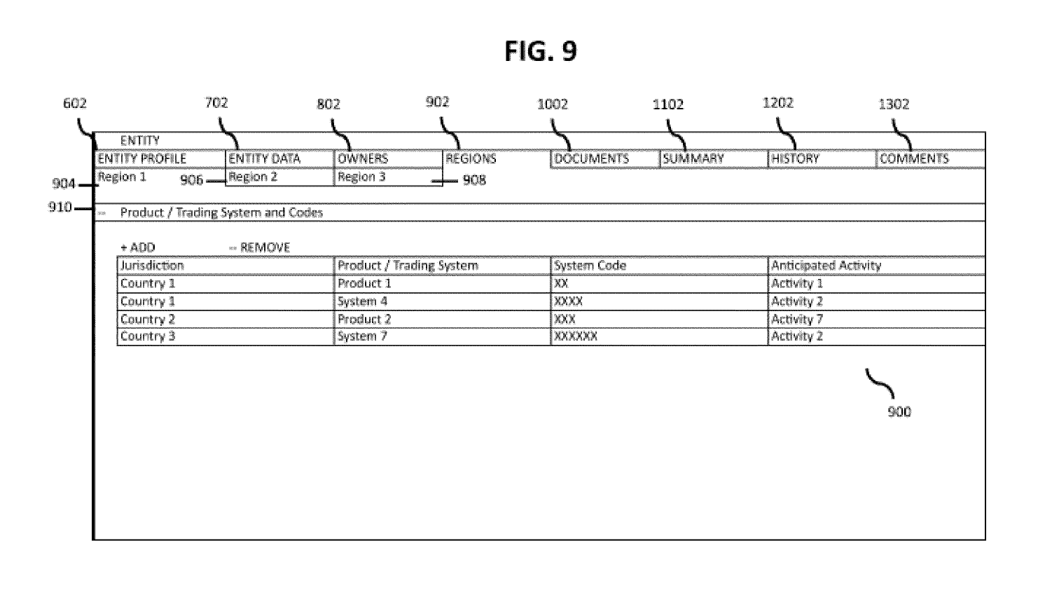

As illustrated in block 510 of FIG. 5, the first user 4 may select the region tab 902 in order to access the region interface 900 allowing the first user 4 to view, add, update, or remove (e.g., edit) regional data related to the entity on-boarded or being on-boarded, as illustrated in FIG. 9. The region interface 900 may include sub-tabs (e.g. Region 1 904, Region 2 906, and Region 3 908) for various regions in which the entity is operates. Within, for example, the Region 1 tab 804 the first user 4 may view, add, update, or remove (e.g., edit) information related to the operations of entity in specific countries within the region. For example, as illustrated by the region interface 900 the first user 4 may populate the interface with information relating the countries in the region, products or trading system being used by the entity in the region, the system codes for the trading systems, and the anticipated activity of the entity for the products within the countries in the regions.

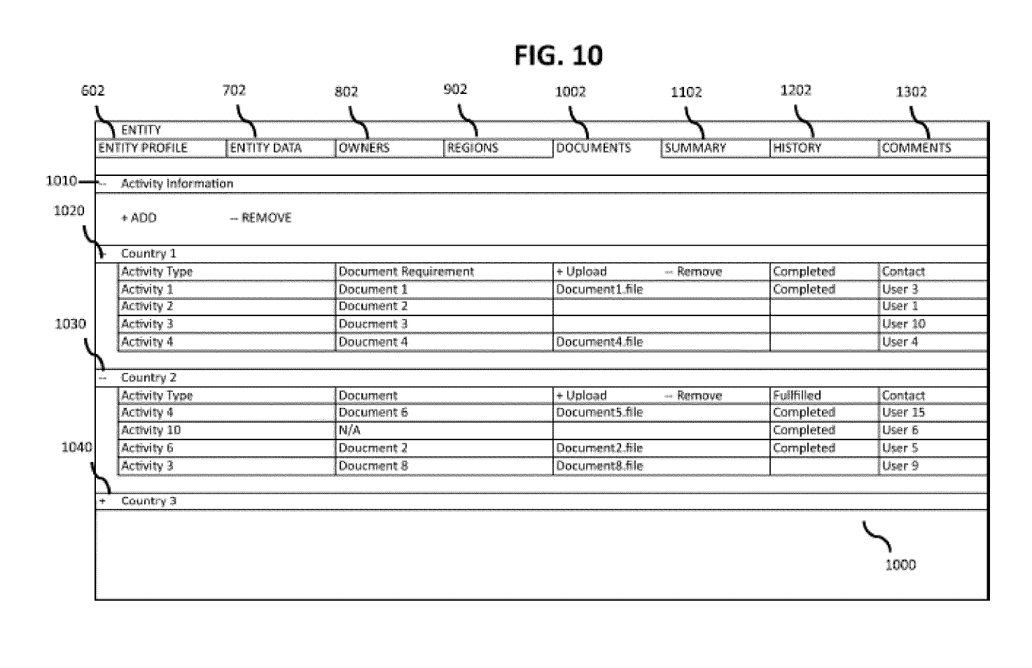

As illustrated in block 512 of FIG. 5, the first user 4 may select the documents tab 1002 in order to access the documents interface 1000 allowing the first user 4 to view, add, update, or remove (e.g., edit) documents and related information to the entity on-boarded or being on-boarded, as illustrated in FIG. 10. The documents interface 1000 illustrates an activity section 1010 that includes country sections 1020, 1030 in which the activities of the entity are listed with respect to each country in which the entity participates in various activities. As illustrated with respect to the country 1 section 1020, the section may include information about the one or more activities taken by the entity, the documents associated with the activity, an unloadable document, an indication of fulfillment of the document requirements, and contact information for the activity and or the associated document. In some embodiments, the document section provides information about the document that is needed for the particular activity within the particular country.

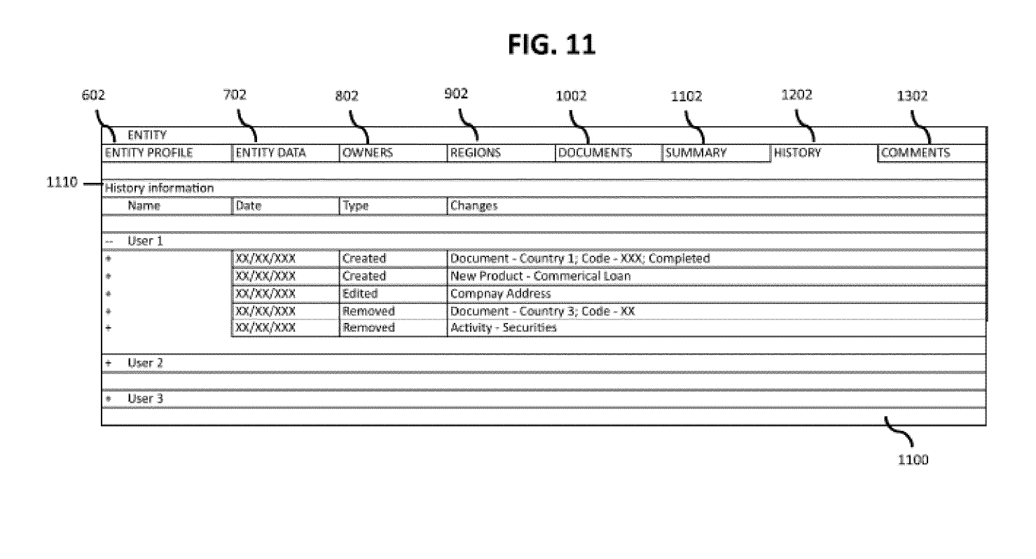

As illustrated in block 514 of FIG. 5, the first user 4 may select the history tab 1102 in order to access the history interface 1100 allowing the first user 4 to view history data related to the actions taken by various users within the history interface 1100 for the entity on-boarded or being on-boarded, as illustrated in FIG. 11. The history interface 1100 may include a history information section 1110, which includes the name, data, type, and changes made by users within the user interfaces 150 (e.g., the other tabs in the on-boarding application). The data related to a specific user may be expanded and hidden to view information related to the actions that a user has taken within the user interface 150.

As illustrated in block 516 of FIG. 5, the first user 4 may also select the summary tab 1202 in order to access a summary interface (not illustrated) that illustrates a summary of the other tabs created by the viewer to provide an overview of the entity on-boarded or being on-boarded.

As illustrated in block 518 of FIG. 5, the first user 4 may select the comments tab 1302 in order to access a comments interface (not illustrated) allowing the first user 4 to view, add, update, or remove (e.g., edit) comments related to the entity on-boarded or being on-boarded.

Block 520 illustrates that the on-boarding application 17 in the integration framework system 100 receives indications that the first user 4 has added, updated, or removed information (e.g., edited) as described with respect to blocks 502 through 518 to on-board an entity for participating in transactions with the institution that is on-boarding the entity. Since the on-boarding application 17 is created through the integration framework system 100 the on-boarding application 17 has the benefits previously discussed herein. Therefore, in some embodiments of the invention one or more of the questions displayed within the user interfaces discussed with respect to blocks 502 through 518 may be displayed in a form in which the first user 4 can view but not take actions on the information. In other embodiments of the invention, one or more of the questions may not even be displayed to the first user 4 if the first user does not meet the entitlement data type in the entitlement data file 116. In some embodiments of the invention entire entities may be hidden from particular users, for example from users that do not have clearance to review the on-boarding information for the particular entities.

As illustrated by block 522 of FIG. 5, in one embodiment of the invention an entity may be on-boarded by one or more users in one or more regions. As such conflicting information may be included in the on-boarding application 17 between different users that are currently on-boarding or have on-boarded the entity in the past. This conflicting information may be identified as previously discussed with respect to the workflow engine 160. Therefore, as the first user 4 is viewing, adding, updating or removing (e.g., editing) data in the user interfaces for an entity, the workflow engine 160 is searching for conflicting information that other users have on-boarded for the same entity, and as such the on-boarding application 17 may notify the first user 4 that conflicting information may exist within the on-boarding application 17 for one or more actions taken by the first user 4 and other users within the on-boarding application 17. For example, the entity's tax information entered by the first user 4 in the entry profile interface 600 is different from another user's entry of tax information for the same entity. The notification provided to the first user 4 may be a pop-up window, message, e-mail, or other like notification that indicates to the first user 4 that there is conflicting information related to the on-boarded entity.

As illustrated by block 524, a notification for user actions may be sent to other users within the on-boarding application 17. For example, if a first user 4 uploads a document for a particular type of activity of a company and indicates that the document requirement is fulfilled, then before the document is approved for being listed as fulfilled a notification may be sent to a second user 6 that has approval access for the actions of the first user 4. The second user 6 logs into the on-boarding application 17 and approves that the document is proper, or otherwise approves that the first user 4 has completed the document requirements. Other notifications may also be sent to users, such as but not limited to requests for information to be sent to particular users or lines of business, notifications to users to complete particular sections within the user interfaces 150, or other like notifications.

Block 526 illustrates, that after notifications are sent a second user 6 may log into the on-boarding application 17 to add, update, or remove (e.g., edit) or view information the user interfaces 150. In other embodiments, the second user 17 may not receive a notification, and is simply logging into the user interface 150 to on-board an entity or continue on-boarding an entity. As previously discussed with respect to the integration framework system 100 in general, the user interface 150 for the on-boarding application 17 displayed to the second user 6 is displayed based on the second user's entitlements, the user's preferred style-sheet, the region in which the user is located, and other user profile information, such as the language in which the user wishes to view the user interface 150 for the on-boarding application 17.

Block 528 of FIG. 5, further illustrates that reporting and data distribution services for the on-boarding application 17 may be applied to the data in on-boarding application 17 to provide reports regarding the on-boarding status of specific entities, status of entity products, entity documents, or the like. The reporting and data distribution services also may utilize entitlement and privacy features that have been previously discussed throughout this specification in order to control the information that can be disseminated through the on-boarding application 17. The reporting service through the reporting engine 180 may be utilized to report entity information, product information, or transactions information to regulatory bodies. For example, sending regulatory reports to the regulatory agencies in different regions and/or countries. The data distribution services may interact with various applications and systems inside and outside of the institution to monitor the entities that have been on-boarded or are in the process of being on-boarded when entity, product, or transaction information changes. For example, the on-boarding application 17 may interact with regulatory bodies to notify the users when entities have been flagged for regulatory issues. The on-boarding application may also be used to restrict or close a relationship with an entity by changing the products or transactions for which the entity has been on-boarded.

As illustrated by block 530 of FIG. 5 the on-boarding application 17, as is the case with other application within the integration framework system 100, may interact with other applications inside and outside of the institution that allow the data related and used within the on-boarding application 17 to be sent downstream for use by other applications. As an example, the data (e.g., entitlement data, user action data, or the like) related to the on-boarded entities may be stored as “.xml” files, and thus, be provided to other applications and displayed in other formats, such as “.html.”

In addition to the on-boarding application 17 functions already discussed herein, the on-boarding application 17 is able to allowing drafting and saving of the on-boarding for various entities over time as the information for the entities is determined, identified, and changes.

The on-boarding application is described herein with respect to a first user 4 and a second user 6, but it should be understood that the actions taken by the first user 4 may also be taken by the second user 6, and vice versa, as well as by one or more other users. As such, the actions described herein may be taken by any user that is has been given the authority to take actions through the entitlement data file 116 or through other authorization.

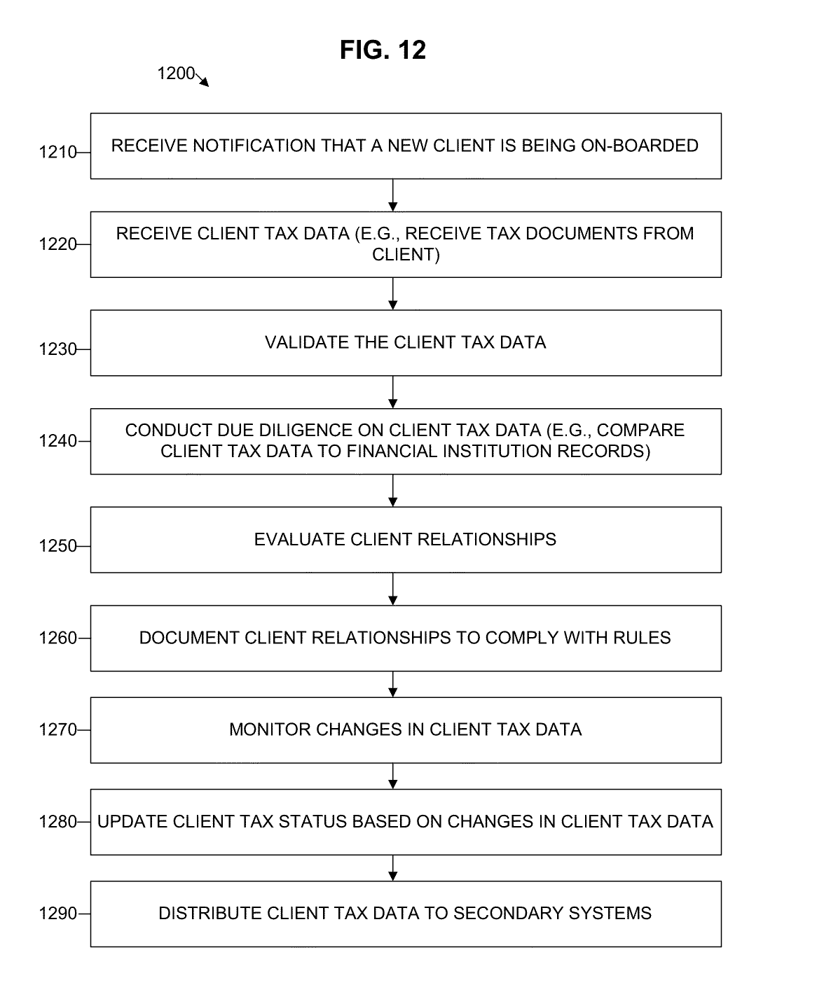

Turning now to FIG. 12, a high level process 1200 for evaluating tax compliance is provided, in accordance with an embodiment of the invention. In some embodiments, the process includes: receiving at least one document comprising client tax data during an on-boarding process for a financial institution; validating the at least one document by: identifying a schema for the at least one document, and determining that the at least one document comprises input in all fields based on the schema; extracting tax data from the at least one document; receiving at least one financial institution record associated with the client, wherein the at least one financial institution record is received from a database; comparing the tax data to the at least one financial institution record to identify inconsistencies; transforming client data based on the comparison of the tax data to the at least one financial institution record; and generating a report comprising the transformed client data.

In an embodiment, the system transforms customer data, such as customer data extracted from tax documents and/or customer data present in financial institution records, by adding to the data and/or modifying the data. In this manner, the transformed data are presented to the user and/or downstream applications in order to confirm that the data are compliant with laws, rules, and regulations. The transformation creates formatted data that is extracted from tax documents, validated, and compared against financial institution records. In some embodiments, a key is inserted into the data to confirm that the transformed tax data are compliant.

In an embodiment, the tax compliance system operates via an efficient and streamlined system. In this embodiment, one or more servers do their own jobs but also provide for load balancing via intelligent algorithms. For example, the servers may include a grid framework for data rows and allow a user to click on user indicia info in the rows. The grid framework provides a faster way to render data onto a screen and includes both sequences of actions as well as a list of actions. In some embodiments, the tax compliance system is container agnostic, which means that the system can be implemented on a variety of hardware types with minimal changes to coding. In some embodiments, the tax compliance system focuses on transfers of data and transformations of the data between containers, such as servers, databases, and the like.

In one embodiment, the system includes a document object model (DOM). In some embodiments, the system uses open source technology to lower operating costs. This open source technology may include Eclipse Link Moxy for XML conversion. In some embodiments, the Jackson library is used as a multi-purpose Java library for processing specific data formats for use with XML. Jackson increases the speed at which lists in the grid are displayed in GUIs. In another embodiment, the inbox in the tax compliance system uses the Spring Framework, which is an open source application framework for Java.

In some embodiments, the system integrates with existing technology such as with RACE, a rules engine. In some embodiments, the hardware is coded with rules directed to business questions that need answers. For example, a question related to whether a new tax form needs to be prepared is a business question and may depend upon changes in the tax data associated with the client being onboarded or monitored. The rules may be built in an implemented via the hardware and software disclosed herein. In some embodiments, the system is also integrated with a workflow engine, such as Activiti, to streamline the process and initiate further steps in the process. In still further embodiments, the system includes data distribution services, such as GPBS services.

In some embodiments, the system is integrated with multiple upstream and downstream applications and includes automated data maintenance routines and a help desk support tool. The hardware and software may send approval messages for onboarding, corporate action information (e.g., new tax form required), and client coverage information (e.g., reporting of status). The downstream integration assists other elements of the financial institution, such as servicing and fulfillment, credit services, deposit ops, and treasury products, comply with laws, rules, and regulations.

In some embodiments shown in block 1210, the system receives a notification that a new client is being on-boarded. In some embodiments, the client is being on-boarded via the system and method disclosed in FIGS. 1-11 and U.S. patent application Ser. No. 13/952,295 to Maguire et al., entitled “On-boarding Framework,” incorporated herein by reference. For example, the system may receive an indication from a user that an entity such as a new business customer may be on-boarded as a financial institution customer. The system may receive information from the user, cross-check the information, and provide assistance in establishing the necessary accounts and connections to assist the user in performing financial functions. In an embodiment, the entity also desires and/or requires assistance in compliance with tax rules.

In an embodiment, the system pro-actively monitors account opening or account status to determine client tax onboarding needs and/or regulation needs. In some embodiments, data received during the account opening process is used to facilitate compliance with tax rules and regulations. For example, tax filing status may be received during the account opening process. This tax filing status may be used to determine the requirements for compliance with tax rules and regulations. In this way, the requirements for the client are identified as part of the onboarding process and the system to assist in tax compliance can determine whether the client complies with these requirements by performing due diligence on financial institution data and tax records of the client.

In an embodiment, the system receives the indication from another element of the system. For example, part of the on-boarding process may include conducting a process for evaluating tax compliance. In some embodiments, the on-boarding process disclosed in, for example, FIG. 5 triggers a tax compliance process. Just as information checks for contact information, account information, and the like can be confirmed, tax compliance can also be confirmed via a process that integrates or compares financial institution specific data as well as client-submitted data. In some embodiments, the system receives the indication automatically as part of an initial on-boarding process for all entities. In other embodiments, however, a user requests tax compliance review, an entity requests tax compliance review, or a third party such as a government agency request tax compliance review.

In an exemplary embodiment, the notification is a message from the on-boarding system. The notification may include the tax information provided by the client as part of the on-boarding information. In some embodiments, the notification includes information associated with the client, such as mailing address, financial transaction information, current and past tax documents, and the like.

In an embodiment shown in block 1220, the system receives client tax data. In an embodiment, the system receives the client tax data to confirm that the client is accurately reporting its status as well as to confirm that the institution data associated with the client is correct.

Client tax data is a broad phrase that means tax documents provided by the entity, a third party (e.g., an accountant or accounting firm), documents that are publicly available (e.g., public filings and the like), or documents generated or stored by a financial institution. In some embodiments, the financial institution supplements the client tax data with financial transaction data, such as records of purchases or sales, tax basis for transactions, records of transfers, organizational information (e.g., mergers and acquisitions), and other information available to the financial institution as client tax data.

In some embodiments, the client tax data are received electronically. For example, a database or spreadsheet listing the information for the client may be provided to the financial institution. In some embodiments, however, the client tax data are received in hard copy form, such as paper documents, or as documents from which data cannot be easily retrieved, e.g., pdf files. In this embodiment, the system may use character recognition to convert the hard copy or non-accessible data into electronic data types. In a further embodiment, an employee of the institution may review the client tax data and manually input the data into a database or spreadsheet.

In some embodiments shown in block 1230, the system validates the client tax data. In an embodiment, the system validates the client tax data to confirm that the data that is expected to be present is present. For example, the system may use software to confirm the presence of text in scanned forms. The presence of the text indicates that the client has at least provided some information relating to the subject. In an embodiment, validating means that the client has provided data that can be compared to financial institution data. Validation does not confirm the accuracy of the data, but merely confirms that the process can continue. In an embodiment, validating comprises reviewing a schema for a tax document. The schema provides the layout of fields and required information for the tax document.

In an embodiment shown in block 1240, the system conducts due diligence on the client tax data. In an embodiment, due diligence is a process by which the system evaluates the client tax data to confirm that it is accurate, to initiate any necessary changes, and to assist the client with conforming with tax rules.

In an embodiment, due diligence is conducted when the client is initially on-boarded and may also be continuously or intermittently monitored to confirm that the client's situation has not changed and resulting in changed circumstances. Due diligence may be automatically conducted when the client tax data are received or may be requested by a user (e.g., a financial institution employee, a client representative, a third party such as a government agency or an accountant).

In some embodiments, due diligence comprising receiving identifying accounts at the financial institution associated with the customer, receiving the financial institution records in the accounts, and comparing the client tax data to the financial institution records. The accounts may be identified based on the name or an identification number associated with the client, such as a tax ID number or a financial institution specific number. Once the accounts are identified, the data associated with the client may be transmitted from the financial institution to the system.

In an embodiment, the system receives both the client tax data as well as financial institution data associated with the client and compares the records to identify consistencies and inconsistencies in the data. For example, the system may compare the name, address, entity status, country of incorporation, financial information, tax ID, and/or tax exchange listed on. In an embodiment, the information from the client tax data must be identical to the financial institution data. In other embodiments, however, the system is configured to identify minor inconsistencies, such as abbreviations, and ignore or flag them at a lower priority level. For example, client tax data may recite an address comprising the word “Street.” The financial institution data may recite the address comprising the abbreviation “St.” The system may flag this minor inconsistency as something that should be corrected, or automatically correct it in the financial institution data.

In some embodiments, the system also confirms that client tax data are present. For example, the system may confirm that the articles of incorporation are on file for the entity. In other embodiments, the system evaluates relationships for the entity to confirm that the entity complies with tax rules. For example, the system may determine whether there are U.S. indicia (e.g., a mailing address, transaction information, or the like) that indicate that the entity has a relationship in the U.S.

In some embodiments shown in block 1250, the system evaluates client relationships. As discussed, client relationships include relationships to jurisdictions. For example, FATCA requires that foreign financial institutions, such as banks, to enter into an agreement with the IRS to identify their U.S. person account holders and to disclose the account holders' names, TINs, addresses, and the transactions of most types of accounts. In an embodiment, the system evaluates to confirm that the entity remains a foreign financial institution and does not have a threshold level of contacts with the U.S. In one embodiment, the system evaluates relationships by identifying data associated with the client that indicates a connection to the U.S.

In an embodiment shown in block 1260, the system documents client relationships to comply with rules. In some embodiments, the system evaluates data to confirm that the client complies with the rules. In one example, the system records the data that may potentially indicate a U.S. relationship to confirm that the entity does not have a U.S. relationship. In this example, the address, the articles of incorporation, the tax exchange, and the like are recorded and confirmed as indicating that the entity does not have a U.S. relationship.

While FATCA is used an example of one type of rule, the client tax data may be evaluated in light of other laws, regulations, and the like. For example, the financial institution may have rules associated with client communication and require consistency between the client tax data contact person and the contact person associated with the client in the financial information data.

In an embodiment shown in block 1270, the system monitors changes in client tax data. In an embodiment, the system monitors anti-money laundering data of the client stored by the financial institution to determine whether changes in the AML data for the client should result in changes in tax forms or tax status for the client. For example, the client may periodically, e.g., quarterly, update its tax data in publicly-available government filings. The institution monitors AML data associated with the client and determines whether these filings should be changed. Some examples of changes that the system may identify include changes in address, changes in tax status (e.g., chapter 3, chapter 4), changes in corporate name, changes in tax ID number, and the like.

In some embodiments shown in block 1280, the system updates client tax status based on changes in client tax data. For example, the system may update withholding levels based on the most recent financial institution data associated with the client. In another embodiment, the system automatically generates reports for filing with governmental agencies. For example, change of address forms may be generated for submission to a government agency. In some embodiments, the change is populated throughout other divisions in the financial institution. For example, tax withholding may increase or decrease based on the change in circumstances. In some embodiments, the system monitors clients for expiration of forms, exemptions, and statuses that will require a client to submit a new tax document.

In an embodiment shown in block 1290, the system distributes client tax data to secondary systems. In some embodiments, the secondary systems are systems such as batch file systems, web services, publishing information, databases, and the like. In some embodiments, the data are distributed using near real-time services and periodic (e.g., nightly) file extracts. In some embodiments, the data are distributed via a batch file. In still further embodiments, the data are distributed via a self-serve access program that allows customers to access their own data.

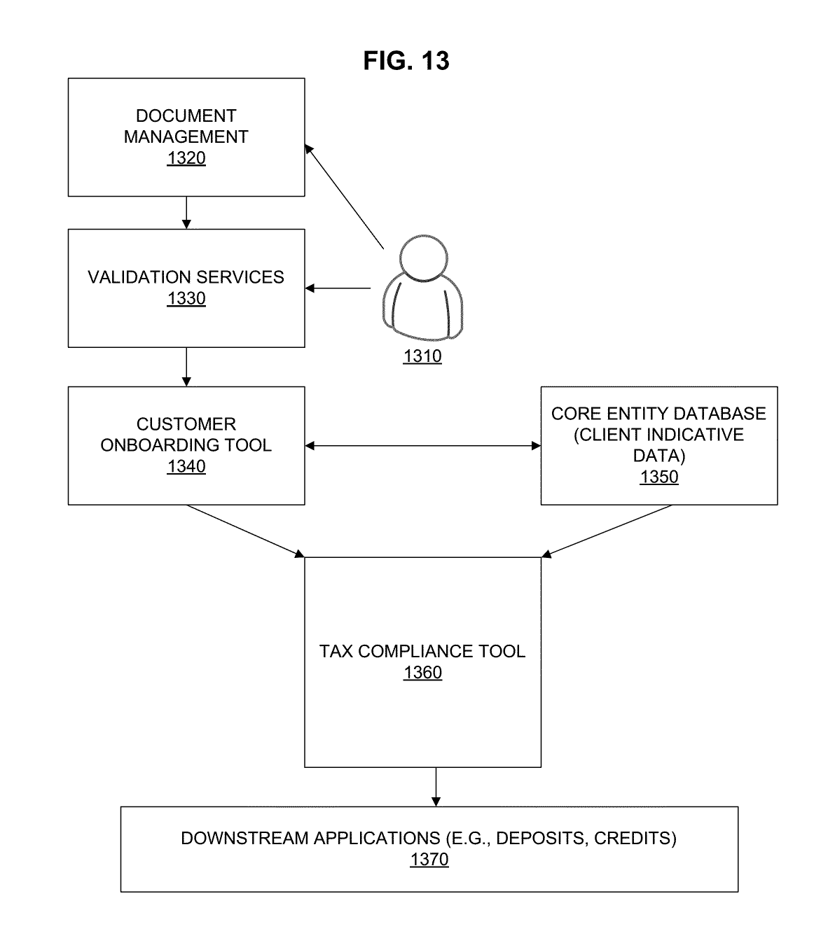

FIG. 13 provides a schematic diagram of elements of the integration framework and tax compliance tool, in accordance with an embodiment of the invention. As shown in FIG. 13, a user 1310 such as a financial institution employee uses the customer onboarding tool 1340 and the tax compliance tool 1360 to assist in on-boarding and compliance of new and existing customers.

In some embodiments, the user 1310 manages documents associated with the customer using a document management tool 1320. In an embodiment, the document management tool stores documents associated with the customer in a database. For example, all tax documents and/or financial information documents from the financial institution that relate to accounts assigned to the customer are stored under a customer number in the database. In some embodiments, the document management system 1320 allows for keyword searching, tagging, searching by owner, searching by last edit date, or the like.

In one embodiment, the document management system 1320 conducts optical character recognition on documents to ensure that the documents are electronically accessible. In other embodiments, the document management system 1320 is connected to manual input devices, such as from associates of the financial institution (e.g., the user 1310) or from external associates (e.g., a contracted party, an affiliated financial institution, a government agency).

In some embodiments, the tax documents received by the document management system 1320 are validated using validation services 1330. In one embodiment, validation means that the documents or electronic versions of the documents are checked to ensure that all information that should be present is present. In some embodiments, validation does not check the accuracy of the information but only that information is present. In some embodiments, however, validation also confirms that the data present in the tax form is of the correct type of data. For example, a field in a tax form that includes gross receipts should have a number value associated with it. If the validation services 1330 identifies that the tax form includes a text value associated with the field, then the validation services 1330 may flag the document for further review or correction by the user 1310.

In an embodiment, once the client documents have been input and validated, the customer onboarding tool 1340 on-boards the client as a new client, as discussed in FIGS. 1-11 herein. The tax documents associated with the client are included as part of the on-boarding process, and in some cases assist in the on-boarding process. For example, the tax documents may be used to establish withholding levels, payment levels, and the like. In this case, the tax compliance tool 1360 may operate contemporaneously with or prior to the complete on-boarding process.

In some embodiments, the environment also includes a core entity database 1350. The core entity database 1350 comprises client indicative data such as mailing address, contact information, articles of incorporation, publicly available information such as public filings, and the like. The core entity database may include information from previous accounts of the client with the financial institution or public information. In some embodiments, the client indicative data are received from external sources such as credit bureaus or the like.

In an embodiment, the tax compliance tool 1360 evaluates the tax documents received during the on-boarding process of the customer onboarding tool 1340 and the client indicative data present in the core entity database 1350. As discussed throughout, the tax compliance tool 1360 compares the records associated with the tax documents in the onboarding process to the records associated with the client in the core entity database 1350. Inconsistencies, changes, or absent data are identified and, in some embodiments, corrected or flagged. For example, an inconsistency that indicates the customer may have U.S. contacts and therefore affect the FATCA status of the customer may be flagged and suggestions for curing the inconsistency provided (e.g., investigating and, if possible, changing the mailing address).

In some embodiments, the system populates tax data and/or changes to the customer's status to downstream applications, as shown at 1370. For examples, deposits or credits may be affected as could withholding amounts for meeting government requirements. The tax data can also be provided to external parties, such as government agencies, auditors, or accountants upon receiving permission from the customer.

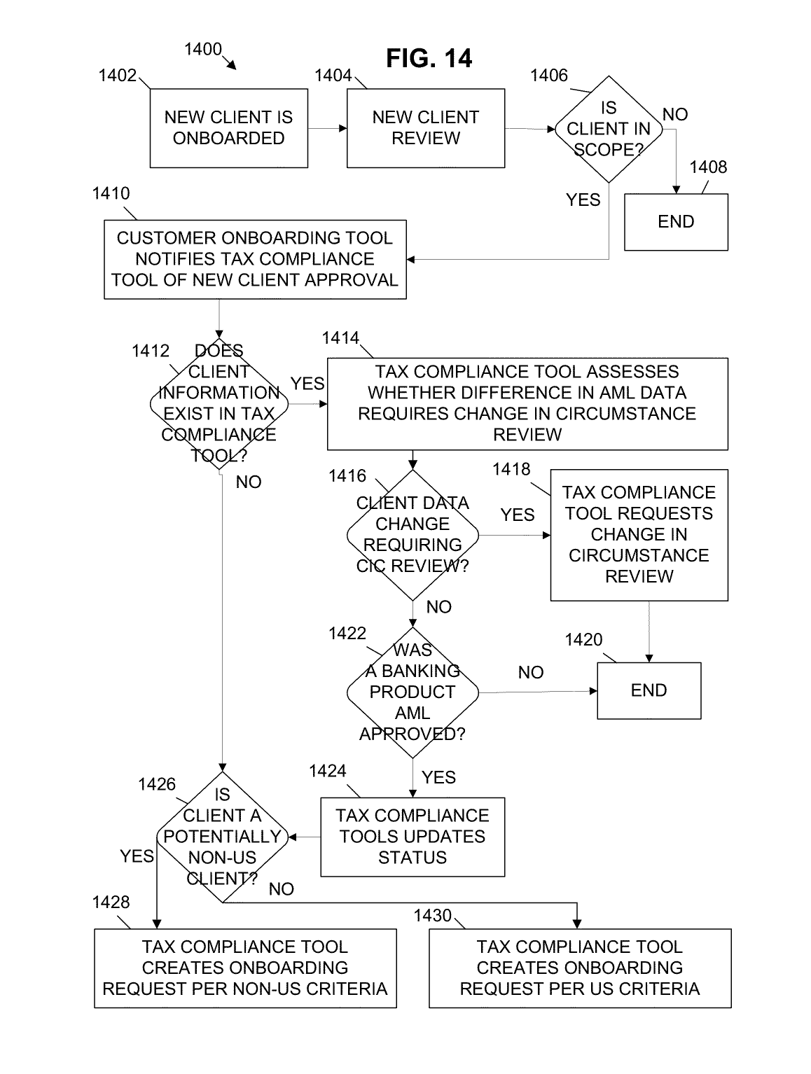

Turning now to FIG. 14, a tax compliance process 1400 using the tax compliance tool is provided, in accordance with an embodiment of the invention. In an embodiment, the tax compliance process shown in FIG. 14 is similar to the tax compliance tool shown in FIG. 12, but includes a check to determine whether a change in circumstances for the client has occurred.

In block 1402, a new client is being onboarded. In an embodiment, the new client is a prospective new client of a financial institution. For example, a financial institution user may be interacting with the prospective new client to set up accounts and the like necessary for a new customer of the financial institution.

In block 1404, new client review occurs based on the tax documents and/or information provided by the new client. For example, the new client may provide tax documents and/or account records that influence the tax withholding status, tax rates, or the like of the client. The financial institution user may also request other information associated with the client, such as mailing address, articles of incorporation, or the like.

In decision block 1406, the system determines whether the new client is in scope of being evaluated via the tax compliance system. In on embodiment, the tax documents provided by the new client are validated. If the tax documents do not pass the validation (e.g., information is missing), the new client is not in scope and the tax compliance process ends, as shown in block 1408.

In block 1410, the customer onboarding tool notifies the tax compliance tool of the new client approval when the client is in scope. In some embodiments, the tax compliance tool operates contemporaneously with the onboarding process or as part of the onboarding process to assist in onboarding the client. In some embodiments, data are passed from the onboarding tool to the tax compliance tool to assist in evaluating the client for tax compliance. In an embodiment, the output transforms the data from both the tax compliance tool and the onboarding tool to result in a transformed data set that provides a specific product to the client for assisting the client in complying with tax requirements.

In decision block 1412, the system determines whether the customer exists in the tax compliance tool already. For example, the client may be a previous client of the financial institution, an entity associated with the client may currently be associated with the financial institution, or public information regarding the client may be available to the institution. For example, a current customer may be restructuring and as part of the restructuring the customer is being onboarded as a new client. In this example, the financial institution already has data associated with the previous client but is also establishing new accounts for the client and therefore will confirm tax compliance for the new entity. Similarly, mergers and/or acquisitions may affect tax compliance of an entity and will be confirmed via the system.

If client data already exists in the tax compliance tool database, tax compliance tool assesses whether differences in anti-money laundering (AML) data requires a change in circumstance review, as shown in block 1414. Anti-money laundering data are data that affect tax status of clients according to various laws, rules, and regulations. For example, AML data may include addresses, contacts, affiliations, and the like.

Differences in AML data between the data received in the new client onboarding process and the data already existing in the database can be evaluated automatically or according to predetermined rules. For example, an exact match between addresses may be required or a match according to rules for abbreviations and the like may be permitted. For example, “Street,” “St.,” and “St,” may be considered analogous by the system.

In decision block 1416, the system determines whether the client data change requires change in circumstances (CIC) review. For example, if a client mailing address lists a headquarters in France on new tax documents but listed a headquarters in the U.S. in information previously stored for the client in the tax compliance tool, the system may determine that the change in client data (mailing address) requires a change in circumstance review, as shown in block 1418. If, however, the change in client data does not require a change in circumstance review, such as because of predetermined rules (e.g., the new client tax data includes a mailing address with the abbreviation “St.” but the previous data includes the same mailing address but the word “Street.”), then the system determines whether the banking product was AML approved, as shown in block 1422.

If the tax compliance tool requires a change in circumstance review, the tax compliance tool will request the CIC review, as shown in block 1418. A change in circumstance review is performed by financial institution employees or other individuals, such as auditors or the like. The change in circumstances review is a review relating to documentation and provides a time period, such as ninety days, for the documentation and/or records to be updated. The change in circumstance review ends the tax compliance process because the review is, in some embodiments, performed manually, as shown in block 1420.

If the change in the client data does not require a change in circumstances review, the process then determines whether the banking product was AML approved. An AML approved banking product is a banking product that does not trigger AML alerts, such as products that may not be permitted in a particular country or products for which data are not available. If the product is not AML approved, the process also ends because the tax compliance system is unable to evaluate the banking product, as shown in block 1420.

If, however, the change in client data does not require a change in circumstances review and if the banking product is AML approved, then the system updates the client status based on the change in client data, as shown in block 1424, and continues as if client data was not changed. The updating may occur in the tax data received from the client, the information already stored or publicly available about the client, or both.

In decision block 1426, the system determines whether the client is a potentially non-US client. For example, the system determines whether the client qualifies as having U.S. connections according to FATCA or whether the client is international. In some embodiments, the system determines whether the client is a potentially non-US client by evaluating client data to find connections to the U.S., such as mailing addresses, global headquarters, tax filing status, or the like.

If the client is potentially a non-U.S. client, the tax compliance tool creates an onboarding request per non-U.S. criteria, as shown in block 1428. For example, during the onboarding process for a non-U.S. client, documents required to be filed with the U.S. government according to FATCA may be prepared for the client. Similarly, withholding status may be adjusted so that the client complies with federal requirements.

If the client is not a non-U.S. client—that is, if the client has U.S. connections that indicate the client is associated with the U.S. or is a U.S. corporation, then the tax compliance tool creates an onboarding request per U.S. criteria. In this embodiment, documents created during the onboarding process are generated based on the client being a U.S. corporation.

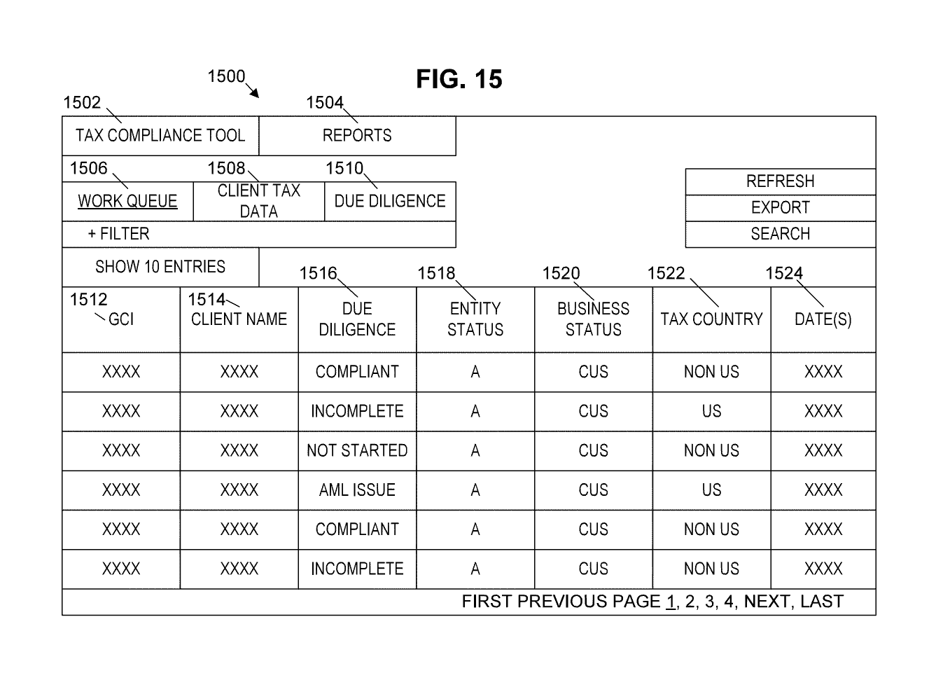

FIG. 15 illustrates an exemplary graphical user interface for reviewing and displaying a work queue for the tax compliance tool, in accordance with an embodiment of the invention. In an embodiment, the graphic user interface 1500 is presented to a user to assist the user in evaluating tax compliance. In some embodiments, the content of the graphical user interface is modified based on the data presented by the client and/or the data presented by the financial institution through the tax compliance tool 1502. The graphical user interface may be on a webpage or presented via an application on a desktop or mobile device. In some embodiments, the graphical user interface is configured to prepare reports 1504 from the tax compliance tool.

In an embodiment, the graphical user interface 1500 includes at least three screens: a work queue 1506, client tax data 1508, and a due diligence screen 1510. FIG. 15 presents an example of the work queue and displays to the user a list of customer numbers (GCI) 1512 and customer names 1514 at various stages of onboarding. The work queue 1506 provides the user with an overview of how many clients are going through the onboarding process as well as the stage and status of those clients.

In some embodiments, the work queue 1506 provides an update on the due diligence status 1516 for the client. For example, the work queue 1506 will provide information on whether the tax status of the client is compliant, incomplete, not started, or if there is an AML issue between the data received from the client and the financial institution data.

The work queue 1506 may also provide a status indicator for the client 1518, a business status 1520, a tax country 1522, and dates associated with the tax compliance tool review of the client 1524. The status indicator may be a way for the institution to further classify clients, such as non-profit or for profit, or the like. The business status may be a way to identify customers (cus) compared to non-customers, potential customers, competitors of customers, or the like. The tax country may be the tax country for purposes of FATCA and may change based on the results of the tax compliance review.

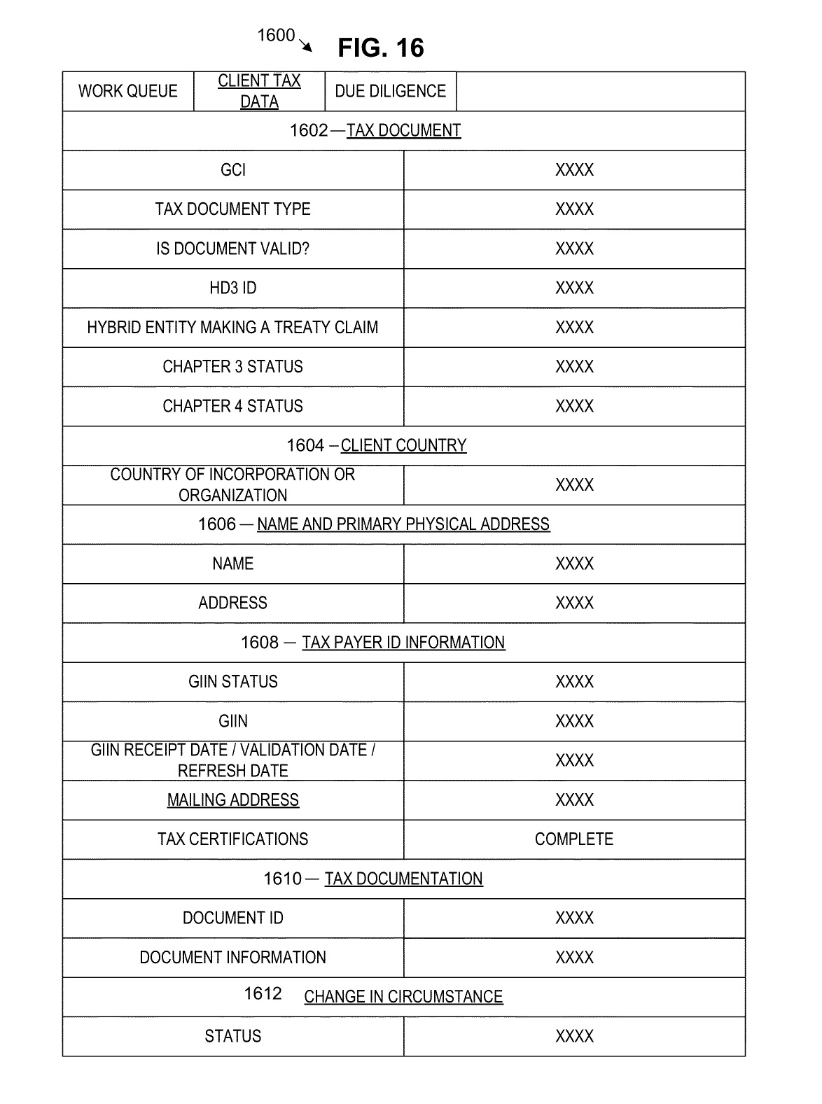

FIG. 16 illustrates an exemplary graphical user interface 1600 for reviewing and displaying client tax data, in accordance with an embodiment of the invention. In some embodiments, the tax document provides information from a tax document submitted by the client. For example, the tax document may be W-8BEN-E (Certificate of Foreign Status of Beneficial Owner for United States Tax Withholding). In an embodiment, the document management system receives the tax document and extracts and/or transforms the data present therein into information for presentation to the user in the client tax data GUI. In some embodiments, the tax form with electronic fields is generated based on the tax document selected by the user.

As shown in FIG. 16, the client tax data may include tax document information 1602, client country information 1604, name and primary physical address 1606, tax payer ID information 1608, tax documentation 1610, and a change in circumstances indicator 1612. For each of these types of information, various fields may be presented to the user. For example, the tax document information may provide information extracted from the tax document and associated with the client number (GCI). For example, the tax document type, the chapter 3 and chapter 4 status, and whether the document is valid or validated may be presented to the user.

Also, FIG. 16 depicts that various other types of information may be provided to the user, such as country of incorporation or organization, GIIN status, whether tax certifications are complete and expiry date, document information, and the like. The client tax data screen provides a convenient location to view tax data provided by the client, as well as transforms some or all of the data for presentation. For example, data from multiple sources may be aggregated into a single GUI in order to assist the user in evaluating the client tax data.

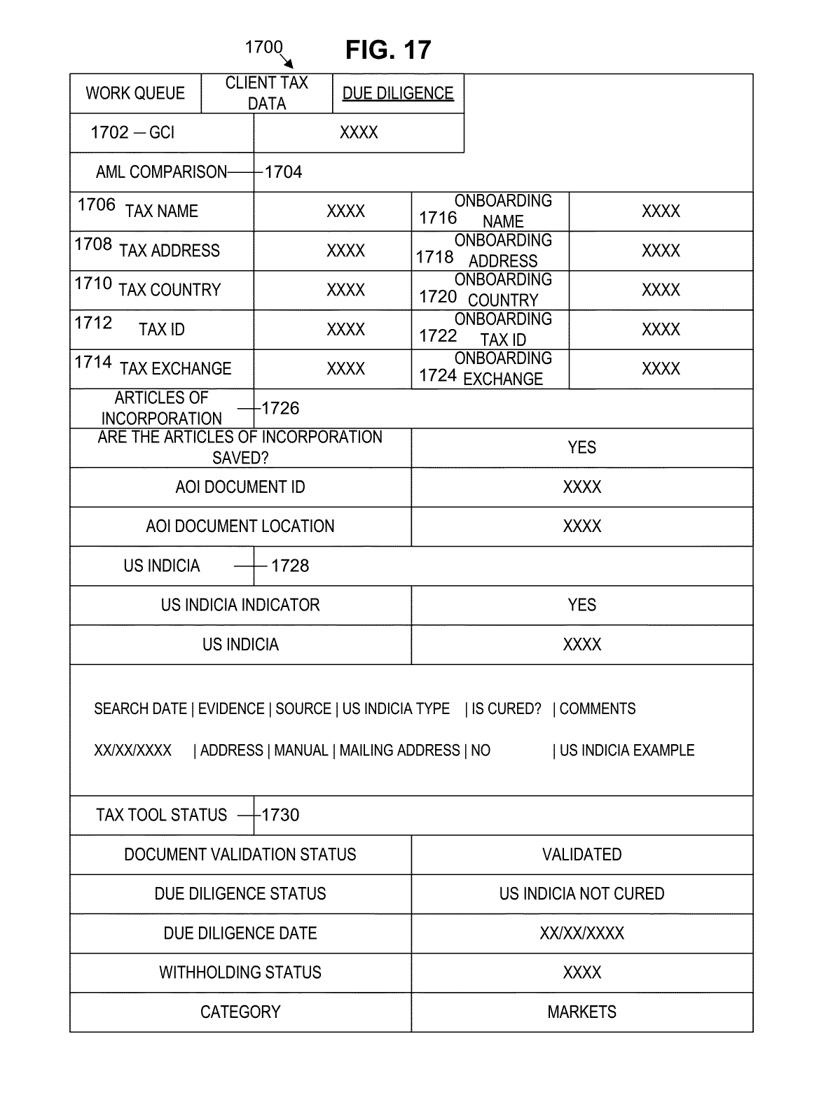

FIG. 17 illustrates an exemplary graphical user interface 1700 for reviewing and displaying the results of due diligence, in accordance with an embodiment of the invention. As shown in FIG. 17, the client number (GCI) 1702 is provided for a specific client and then the AML comparison 1704 proceeds with respect to the tax data received from the client and the financial institution data. Here, tax name 1706, tax address 1708, tax country 1710, tax ID 1712, and tax exchange 1714 extracted from tax forms are compared to financial institution data or data received from the client including onboarding name 1716, onboarding address 1718, onboarding country 1720, onboarding tax ID 1722, and onboarding exchange 1724. Inconsistencies between the tax data and the onboarding or financial institution data can therefore be identified easily and, if necessary, corrected. The due diligence page also provides information regarding the status of the client onboarding, such as whether the articles of incorporation 1726 are saved, the articles of incorporation ID number and document location, and the like. In some embodiments, the presence of specific U.S. indicia 1728 is identified, as well as the specific details of the U.S. indicia such as mailing address or corporate headquarters. Finally, the tax tool status may be provided for a more detailed view of the due diligence process 1730. The status may include details on validation status, due diligence status, dates, withholding status, and the like.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Pearl, Smalltalk, C++ or the like. However, the computer program code/computer-readable instructions for carrying out operations of the invention may also be written in conventional procedural programming languages, such as the “C” programming language or similar programming languages.

Embodiments of the present invention described above, with reference to flowchart illustrations and/or block diagrams of methods or apparatuses (the term “apparatus” including systems and computer program products), will be understood to include that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

U.S. patent application Ser. No. 13/952,258 to Kallikadavil et al., entitled “Integration Framework,” is hereby incorporated by reference in its entirety.

Specific embodiments of the invention are described herein. Many modifications and other embodiments of the invention set forth herein will come to mind to one skilled in the art to which the invention pertains, having the benefit of the teachings presented in the foregoing descriptions and the associated drawings. Therefore, it is to be understood that the invention is not to be limited to the specific embodiments disclosed and that modifications and other embodiments and combinations of embodiments are intended to be included within the scope of the appended claims. Although specific terms are employed herein, they are used in a generic and descriptive sense only and not for purposes of limitation.

What is claimed is:

1. A system comprising:
a memory device having computer readable program code store thereon; and
a processing device operatively coupled to the memory device, wherein the processing device is configured to execute the computer readable program code to:
receive at least one document comprising client tax data during an on-boarding process for a financial institution;
validate the at least one document by:
identifying a schema for the at least one document, and
determining that the at least one document comprises input in all fields based on the schema;
extract tax data from the at least one document;
receive at least one financial institution record associated with the client, wherein the at least one financial institution record is received from a database;
compare the tax data to the at least one financial institution record to identify inconsistencies;
transform client data based on the comparison of the tax data to the at least one financial institution record; and
generate a report comprising the transformed client data.

2. The system of claim 1, wherein the processing device is further configured to execute the computer readable program code to:
identify U.S. indicia associated with the client in at least one of the tax data and the financial institution record;
determine whether the U.S. indicia can be cured according to predetermined rules;
cure the U.S. indicia by modifying at least one of the tax data and the financial institution records; and
update the onboarding process after the U.S. indicia is cured.

3. The system of claim 1, wherein the processing device is further configured to execute the computer readable program code to:
identify differences in anti-money laundering data in the tax data and the financial institution records;
determine when the differences in anti-money laundering data between the tax data and the financial institution records require a change in circumstances review; and
alert a user to the need for a change in circumstances review.

4. The system of claim 3, wherein the processing device is further configured to execute the computer readable program code to:
monitor the financial institution data over time;
determine a change in the anti-money laundering data; and
determine whether a tax document should be revised based on the change in the anti-money laundering data.

5. The system of claim 4, wherein the processing device is further configured to execute the computer readable program code to:
generate a revised tax document based on the change in the anti-money laundering data; and
provide the revised tax document to a user.

6. The system of claim 1, wherein the report comprising the transformed client data is customized for the client based on U.S. indicia associated with the client, wherein a client that has U.S. indicia is onboarded according to U.S. rules and wherein a client that does not have U.S. indicia is onboarded according to non-U.S. rules.

7. The system of claim 1, wherein the processing device is further configured to execute the computer readable program code to:
populate the transformed tax data to other departments of the financial institution.

8. A computer program product, the computer program product comprising at least one non-transitory computer-readable medium having computer-readable program code portions embodied therein, the computer-readable program code portions comprising:
an executable portion configured to receive at least one document comprising client tax data during an on-boarding process for a financial institution;
an executable portion configured to validate the at least one document by:
identifying a schema for the at least one document, and
determining that the at least one document comprises input in all fields based on the schema;
an executable portion configured to extract tax data from the at least one document;
an executable portion configured to receive at least one financial institution record associated with the client, wherein the at least one financial institution record is received from a database;
an executable portion configured to compare the tax data to the at least one financial institution record to identify inconsistencies;
an executable portion configured to transform client data based on the comparison of the tax data to the at least one financial institution record; and
an executable portion configured to generate a report comprising the transformed client data.

9. The computer program product of claim 8, wherein the computer-readable program code portions further comprise:
an executable portion configured to identify U.S. indicia associated with the client in at least one of the tax data and the financial institution record;
an executable portion configured to determine whether the U.S. indicia can be cured according to predetermined rules;
an executable portion configured to cure the U.S. indicia by modifying at least one of the tax data and the financial institution records; and
an executable portion configured to update the onboarding process after the U.S. indicia is cured.

10. The computer program product of claim 8, wherein the computer-readable program code portions further comprise:
an executable portion configured to identify differences in anti-money laundering data in the tax data and the financial institution records;
an executable portion configured to determine when the differences in anti-money laundering data between the tax data and the financial institution records require a change in circumstances review; and
an executable portion configured to alert a user to the need for a change in circumstances review.

11. The computer program product of claim 10, wherein the computer-readable program code portions further comprise:
an executable portion configured to monitor the financial institution data over time;
an executable portion configured to determine a change in the anti-money laundering data; and
an executable portion configured to determine whether a tax document should be revised based on the change in the anti-money laundering data.

12. The computer program product of claim 11, wherein the computer-readable program code portions further comprise:
an executable portion configured to generate a revised tax document based on the change in the anti-money laundering data; and
an executable portion configured to provide the revised tax document to a user.

13. The computer program product of claim 8, wherein the report comprising the transformed client data is customized for the client based on U.S. indicia associated with the client, wherein a client that has U.S. indicia is onboarded according to U.S. rules and wherein a client that does not have U.S. indicia is onboarded according to non-U.S. rules.

14. The computer program product of claim 8, wherein the computer-readable program code portions further comprise:
an executable portion configured to populate the transformed tax data to other departments of the financial institution.

15. A method comprising:
receiving, by a processing device, at least one document comprising client tax data during an on-boarding process for a financial institution;
validating, by the processing device, the at least one document by:
identifying a schema for the at least one document, and
determining that the at least one document comprises input in all fields based on the schema;
extracting, by the processing device, tax data from the at least one document;
receiving, by the processing device, at least one financial institution record associated with the client, wherein the at least one financial institution record is received from a database;
comparing, by the processing device, the tax data to the at least one financial institution record to identify inconsistencies;
transforming, by the processing device, client data based on the comparison of the tax data to the at least one financial institution record; and
generating, by the processing device, a report comprising the transformed client data.

16. The method of claim 15, wherein the method further comprises:
identifying U.S. indicia associated with the client in at least one of the tax data and the financial institution record;
determining whether the U.S. indicia can be cured according to predetermined rules;
curing the U.S. indicia by modifying at least one of the tax data and the financial institution records; and
updating the onboarding process after the U.S. indicia is cured.

17. The method of 15, wherein the method further comprises:
identifying differences in anti-money laundering data in the tax data and the financial institution records;
determining when the differences in anti-money laundering data between the tax data and the financial institution records require a change in circumstances review; and
alerting a user to the need for a change in circumstances review.

18. The method of 17, wherein the method further comprises:
monitoring the financial institution data over time;
determining a change in the anti-money laundering data; and
determining whether a tax document should be revised based on the change in the anti-money laundering data.

19. The method of 18, wherein the method further comprises:
generating a revised tax document based on the change in the anti-money laundering data; and
providing the revised tax document to a user.

20. The method of claim 15, wherein the report comprising the transformed client data is customized for the client based on U.S. indicia associated with the client, wherein a client that has U.S. indicia is onboarded according to U.S. rules and wherein a client that does not have U.S. indicia is onboarded according to non-U.S. rules.
